(19) United States
(12) Patent Application Publication
(10) Pub. No.: US 2017/0255885 A1
(43) Pub. Date: Sep. 7, 2017

(54) COMPUTER SYSTEM AND METHOD FOR MODELLING A BUSINESS OPERATION

(71) Applicant: INDEVA LIMITED, Twyford, Berkshire (GB)

(72) Inventors: Michael WHITESIDE, Twyford, Berkshire (GB); Kazimerz Zygmunt LIBROWSKI, Welford on Avon, Warwickshire (GB)

(21) Appl. No.: 15/506,636

(22) PCT Filed: Aug. 19, 2015
(86) PCT No.: PCT/GB2015/052408

§ 371 Date: Feb. 24, 2017

(30) Foreign Application Priority Data
Aug. 28, 2014 (GB) 1415230.0

(51) Int. Cl. G06Q 10/06

(52) U.S. Cl. CPC G06Q 10/0631; G06Q 10/067

(57) ABSTRACT

A computer system and method for modelling a business operation in which parameters for the instantiation of at least one process module are received from a user interface, each process module representing an element of the business operation and having at least one output port and at least one input port, each input port having at least one label, each label for an input port comprising at least one characteristic of a parameter required for input to the process module, each output port having at least one label, and each output port label comprising at least one characteristic of a parameter output by the process module, wherein the labels for the input and output ports are defined in structured data in sets; the parameters for the at least one process module are stored; and a plurality of process modules are instantiated using at least one processor to implement a model of the business operation by connecting inputs of modules to outputs of modules using the labels for the input and output ports to form a dependency network of modules.

### FIELD OF THE INVENTION

The present invention relates to a system and method of modelling a business operation.

### BACKGROUND OF THE INVENTION

To assist businesses to implement effective strategies their operations can be modelled based on assumptions about decisions and uncertain parameters in the future. Computer implemented models simulating operational parameters of a business enable business managers to simulate the impact of decisions on the operation of the business. Also, the use of a structured model of the processes in an business operation facilitates the management of the operation.

Spreadsheets have been used for the solution to modeling parameters, decisions and the behaviour of the business. The benefit of the use of spreadsheet software is its familiarity to the users and its flexibility. However, spreadsheets have significant limitations in their ability to model the operation and decisions of a business.

### SUMMARY OF THE INVENTION

One aspect provides a method of modelling a business operation using a computer system, the method comprising receiving parameters for the instantiation of at least one process module from a user interface, each process module representing an element of the business operation and having at least one output port and at least one input port, each input port having at least one label, each label for an input port comprising at least one characteristic of a parameter required for input to the process module, each output port having at least one label, and each output port label comprising at least one characteristic of a parameter output by the process module, wherein the labels for the input and output ports are defined in structured data in sets; storing the parameters for the at least one process module; and instantiating a plurality of process modules using at least one processor and the stored parameters to implement a model of the business operation by connecting inputs of modules to outputs of modules using the labels for the input and output ports to form a dependency network of process modules.

Another aspect provides a computer system for modelling a business operation, the system comprising an interface to receive parameters for the instantiation of at least one process module from a user, each process module representing an element of the business process and having at least one output port and at least one input port, each input port having at least one label, each label for an input port comprising at least one characteristic of a parameter required for input to the process module, each output port having at least one label, and each output port label comprising at least one characteristic of a parameter output by the process module, wherein the labels for the input and output ports are defined in structured data in sets; a data store for storing the parameters for the at least one process module; and at least one processor programmed to instantiate a plurality of process modules using the stored parameters to implement a model of the business operation by connecting inputs of modules to outputs of modules using the labels for the input and output ports to form a dependency network of process modules.

Another aspect provides a method of modelling a business operation using a computer system, the method comprising receiving parameters for the instantiation of at least one process object and at least one translation object from a user interface, each process object comprising logic to perform a business function and having at least one input and at least one output, and each translation object comprising logic to convert the form of a parameter of a parameter type output from one process object into a required form for the parameter of the parameter type for input to another process object; storing the parameters for the at least one process object and the at least one translation object; and instantiating a plurality of process objects and translation objects using a processor and the stored parameters to implement a model of the business operation by connecting inputs of process objects to outputs of process objects via translation objects to form a dependency network of objects.

Another aspect provides a computer system for modelling a business operation, the system comprising an interface for receiving parameters for the instantiation of at least one process object and at least one translation object from a user, each process object comprising logic to perform a business function and having at least one input and at least one output, and each translation object comprising logic to convert the form of a parameter of a parameter type output from one process object into a required form for the parameter of the parameter type for input to another process object; a data store for storing the parameters for the at least one process object and the at least one translation object; and at least one processor for instantiating a plurality of process objects and translation objects using the stored parameters to implement a model of the business operation by connecting inputs of process objects to outputs of process objects via translation objects to form a dependency network of objects.

Another aspect provides a method of modelling a business process using a computer system, the method comprising receiving parameters for the instantiation of at least one process object, at least one input connection object, and at least one output connection object from a user interface, each process object comprising logic to represent a business function and requiring at least one input and at least one output, each input connection object comprising logic to input parameters to a process object, and each output connection object comprising logic to output parameters from a process object; storing the parameters for the at least one process object, the at least one input connection object, and the at least one output connection object; and instantiating a plurality of process objects and input and output connection objects using at least one processor and the stored parameters to implement a model of the business operation by connecting inputs of process objects to outputs of process objects via the connection objects to form a dependency network of objects.

Another aspect provides a computer system for modelling a business operation, the system comprising an interface for receiving parameters for the instantiation of at least one process object, at least one input connection object, and at least one output connection object from a user interface, each process object comprising logic to represent a business function and requiring at least one input and at least one output, each input connection object comprising logic to input parameters to a process object, and each output connection object comprising logic to output parameters from a process object; a data stored for storing the parameters for the at least one process object, the at least one input connection object, and the at least one output connection object; and at least one processor for instantiating a plurality of process objects and input and output connection objects and the stored parameters to implement a model of the business operation by connecting inputs of process objects to outputs of process objects via the connection objects to form a dependency network of objects.

Another aspect provides a method of modelling a business process using a computer system, the method comprising receiving parameters to define a new version of at least one process module from a user interface when the parameters are different than for a previous version of the at least one process object, each process module comprising logic to represent a business function and having at least one input and at least one output, each version of a said process module being immutable and the output being dependent upon the input and the version of the process module; storing the parameters for the at least one version of a said process module; and instantiating a plurality of process modules using at least one processor and the stored parameters to implement a model of the business operation by connecting inputs of process modules to outputs of process modules to form a dependency network of process modules, object modules having associated versions being identified and connected to form the dependency network.

Another aspect provides a computer system for modelling a business operation, the system comprising an interface for receiving parameters to define a new version of at least one process module from a user when the parameters are different than for a previous version of the at least one process object, each process module comprising logic to represent a business function and having at least one input and at least one output, each version of a said process module being immutable and the output being dependent upon the input and the version of the process module; a data store for storing the parameters for the at least one version of a said process module; and at least one processor for instantiating a plurality of process modules and the stored parameters to implement a model of the business operation by connecting inputs of process modules to outputs of process modules to form a dependency network of process modules, object modules having associated versions being identified and connected to form the dependency network.

Another aspect provides a method of building a model of a business operation using a computer system, the method comprising receiving parameters for at least one business factor from a user interface, the business factors representing an entity, an activity, or a product associated with the business operation; storing the parameters for at least one business factor; instantiating business objects using at least one processor and the stored parameters to form a dependency network of business modules to determine conformance to requirements in a stored data structure; receiving parameters for at least one process module from a user interface, each process module representing an element of the business process using or relying upon the business factors and having at least one output port and at least one input port; storing the parameters for the at least one process module; instantiating a plurality of process modules using at least one processor and the stored parameters to implement a model of the business operation by connecting inputs of modules to outputs of modules to form a dependency network of process modules.

Another aspect provides a computer system for building a model of a business operation, the system comprising an interface for receiving parameters for at least one business factor from a user, the business factors representing an entity, an activity, or a product associated with the business operation; a data store for storing the parameters for at least one business factor; and at least one processor for instantiating business objects using at least one processor and the stored parameters to form a dependency network of business modules to determine conformance to requirements in a stored data structure; wherein the interface is for receiving parameters for at least one process module from a user interface, each process module representing an element of the business process using or relying upon the business factors and having at least one output port and at least one input port; the data store stores the parameters for the at least one process module; and the at least one processor is programmed to instantiate a plurality of process modules using at least one processor and the stored parameters to implement a model of the business operation by connecting inputs of modules to outputs of modules to form a dependency network of process modules.

Another aspect provides a non-transient storage medium storing computer readable code for controlling at least one processor to carry out any of the above methods.

### BRIEF DESCRIPTION OF THE DRAWINGS

FIG. 1 is a schematic diagram illustrating a system according to one embodiment;

FIGS. 2a, 2b and 2c are schematic diagrams of a process object and associated connection objects according to embodiments;

FIG. 3 is a schematic diagram of a network of process objects showing different version connections according to one embodiment;

FIG. 4 is a schematic diagram of a data structure for object version management according to one embodiment;

FIGS. 5a and 5b are schematic diagrams to illustrate the account merge process according to one embodiment;

FIG. 6 is a schematic diagram illustrating version control on the objects in a dependency network according to one embodiment;

FIG. 7 is a schematic diagram illustrating version control on the objects in a dependency network according to another embodiment;

FIGS. 8, 9, 10 and 11 are schematic diagrams illustrating the data structure representation for business functions used in the business operation according to one embodiment;

FIG. 12 is a schematic diagram illustrating the labels stored as a data sets or in a hierarchy and how the structure is modified as a company structure changes according to one embodiment;

FIG. 13 is a schematic diagram of the structure of FIG. 12 showing only the labels according to one embodiment;

FIG. 14a is a schematic diagram of the structure of FIG. 12 showing only the system nodes and how they are interconnected by association according to one embodiment;

FIG. 14b is a schematic diagram of the structure of FIG. 12 showing the mapping of the versions of the label hierarchies to the version of the model unit in which they are managed according to one embodiment;

FIG. 15 is a schematic diagram illustrating the process of explicit label matching according to one embodiment;

FIG. 16 is a schematic diagram illustrating the process of implicit label matching according to one embodiment;

FIG. 17 is a schematic illustration of the relationship between the structured data defining the business functions (entity type, activity type, product type and variable type) in order to define an instance of labels for an output port according to one embodiment;

FIG. 18 illustrates a data structure for the dimensions described in the model according to one embodiment;

FIG. 19 illustrates the types of transformations that can take place between objects according to one embodiment;

FIG. 20 illustrates one example of the transformation process;

FIG. 21 is a schematic diagram illustrating the process of transformation of parameters between process objects according to one embodiment;

FIG. 22 illustrates the use of objects in a dependency network for the instantiation of a collection according to one embodiment;

FIG. 23 is a diagram illustrating the relationship between model units and accounts together with the way users interact with them according to one embodiment;

FIG. 24 is a flow diagram illustrating the process of creating or modifying components in the global model according to one embodiment;

FIG. 25 illustrates the process for defining a single variable, single module component according to one embodiment;

FIG. 26 illustrates the process for publishing the modification made by a user when the user is satisfied with them in accordance with one embodiment;

FIG. 27 illustrates the process for merging the data of the model in accordance with one embodiment;

FIG. 28 illustrates the forming of a template by selecting a set of objects to template and generalising labels of input and output ports according to one embodiment;

FIG. 29 illustrates the generalisation of the transaction objects as a template for reuse according to one embodiment; and

FIG. 30 illustrates the instantiation of the template according to one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server or servers, or other device capable of processing data including network interconnection devices.

Some embodiments implement the functions in two or more specific interconnected hardware modules with related control and data signals communicated between and through the modules, or as portions of an application-specific integrated circuit. Thus, the exemplary process flow is applicable to software, firmware, and hardware implementations.

A generalized embodiment is directed to a system and method for dynamically modeling a business operation by modeling the entities, activities, products and parameters involved in the operation of the business and how they interact. The model can be updated and adapted and can grow. The parameters can comprise financial, physical, administrative or management parameters such as oil flow, stocks, balances, profit etc. The entities can comprise physical entities or assets, management or organizational entities, or legal entities. Data defining everything required in the operation of a business, such as entities, products, parameters and activities, can be stored as a data structure (a schema) in a set or hierarchical form for example. Data stored hierarchically can be considered a special case of a set of data according to embodiments of the invention. In one embodiment, a computer representation of the data structure can comprise a structured language such as XML.

In one embodiment, the structured data (schema) defines the association structure for the connections between process modules in a dependency network. In one embodiment, the association structure defines a structure of relationships between labels used by process modules for the formation of the connections there between. In one embodiment, the process modules can use connection objects separate to the process objects to form the connections using the labels. The labels can also be stored as a separate data structure e.g. a hierarchy.

In one embodiment, a user interface is provided such as on a client machine so that a server system or the client machine receives user input parameters. The user interface can also be used by the user to view the output of the model such as the parameters output from the process object such as on a display at the client machine either as a result of processing on the client machine or on the server system.

An embodiment provides a modelling system that is highly distributed enabling multiple users to develop, manage and use the model from a distributed network of computers. This is provided for by ensuring a consistent schema defining the entities, activities, products and parameters involved in the operation of the business in any model over multiple model sub units being accessed by users. Any divergence of the schema developed by users must be prevented or managed by merging to bring commonality to the model.

The term business operation or business process is used herein to mean any operation or process performed in business or administration. The model can define a plurality of interrelated or dependent objects having business or administrative functions. The objects in the model can perform calculations or processes, receive or retrieve inputs or parameters, output or store parameters, and can represent, relate to, refer to or be associated with digital content components, such as dynamic digital content components having content dependent upon calculations or processes by process objects.

One embodiment provides a method of modelling a business operation using a computer system, the method comprising receiving parameters for the instantiation of at least one process module from a user interface, each process module representing an element of the business process and having at least one output port and at least one input port, each input port having at least one label, each label for an input port comprising at least one characteristic of a parameter required for input to the process module, each output port having at least one label, and each output port label comprising at least one characteristic of a parameter output by the process module, wherein the labels for the input and output ports are defined in structured data in sets; storing the parameters for the at least one process module; and instantiating a plurality of process modules using at least one processor and the stored parameters to implement a model of the business operation by connecting inputs of modules to outputs of modules using the labels for the input and output ports to form a dependency network of process modules.

In this embodiment, the use of labels defined in sets provides a simple method of connecting the inputs of process modules to the outputs of other process modules. The process modules can be developed and provided to the model environment without the need for manual connections to be made. The system automatically performs the connection process using the labels. Labels can belong to more than one set.

In one embodiment the labels for the inputs and output ports are defined as a hierarchy of labels. In this way, it is possible to use the labels to connect between child and parent and descendant labels as identified in the hierarchy.

In one embodiment the connections between input ports and input ports of modules is determined by determining if the labels of the output ports match with the labels of the input ports, and making the connections where a match is determined. In one embodiment, the input port defines a label search, which is performed on the output port labels of other process modules to identify matches for connections to be made.

In one embodiment the matching is based on matching rules defining matches for labels with identical labels and for labels for sets with labels for members of the respective sets. The matching rules can define matching relationships other than exact matches. For example, the matching rule can identify a set of labels that can match an input and any label in that set is determined to be a match.

In one embodiment each label stores association data identifying the relationship between the label and a label type in the structured data.

In one embodiment the structured data defining the labels comprises a data structure representation of an organization of resources associated with the business process. Hence, the definition of the labels to facilitate label matching can be stored as part of a data structure definition of the assets and entities involved in the business e.g. entities, products, activities, transactions and/or variables involved in the business operation. For speed of access, the label data can additionally be stored independently in a data structure representing a directed network e.g. a hierarchical data structure or a semi-lattice.

In one embodiment the resources comprise entities involved in the business process, parameters involved in the business process, products involved in the business process, activities and transactions between entities or on products.

One embodiment provides a computer system for modelling a business operation, the system comprising an interface to receive parameters for the instantiation of at least one process module from a user, each process module representing an element of the business operation and having at least one output port and at least one input port, each input port having at least one label, each label for an input port comprising at least one characteristic of a parameter required for input to the process module, each output port having at least one label, and each output port label comprising at least one characteristic of a parameter output by the process module, wherein the labels for the input and output ports are defined in structured data in sets; a data store for storing the parameters for the at least one process module; and at least one processor programmed to instantiate a plurality of process modules using the stored parameters to implement a model of the business operation by connecting inputs of modules to outputs of modules using the labels for the input and output ports to form a dependency network of process modules.

One embodiment provides a non-transitory storage medium storing machine readable code for controlling at least one processor to model a business operation, the code comprising code for controlling at least one processor to receive parameters for the instantiation of at least one process module from a user interface, each process module representing an element of the business operation and having at least one output port and at least one input port, each input port having at least one label, each label for an input port comprising at least one characteristic of a parameter required for input to the process module, each output port having at least one label, and each output port label comprising at least one characteristic of a parameter output by the process module, wherein the labels for the input and output ports are defined in structured data in sets; code for controlling at least one processor to store the parameters for the at least one process module; and code for controlling at least one processor to instantiate a plurality of process modules using the stored parameters to implement a model of the business operation by connecting inputs of modules to outputs of modules using the labels for the input and output ports to form a dependency network of modules.

One embodiment provides a method of modelling a business operation using a computer system, the method comprising receiving parameters for the instantiation of at least one process object and at least one translation object from a user interface, each process object comprising logic to represent a business function and having at least one input and at least one output, and each translation object comprising logic to convert the form of a parameter of a parameter type output from one process object into a required form for the parameter of the parameter type for input to another process object; storing the parameters for the at least one process object and the at least one translation object; and instantiating a plurality of process objects and translation objects using a processor and the stored parameters to implement a model of the business operation by connecting inputs of process objects to outputs of process objects via translation objects to form a dependency network of objects.

In this embodiment, the process objects are able to operate on parameters to generate an output in one form without being required to meet the form of the parameter for a dependent process object. The translation object comprises separate logic to assist with the connection between process objects by transforming the form of the parameters output by a process object into a form required by an input of a process object. The transformation objects are not required by all process object connections and are instantiated as required to make business process object connections. The transformation can comprise:
a. unit changes such as imperial to metric
b. unit transformation e.g. units of volume of oil converted to equivalent energy or mass units
c. scale changes e.g. in the time dimension, from irregular to regular divisions, or separately or in combination in a local along road dimension from divisions in tens of meters to divisions at road junctions
d. currency changes, e.g. from Dollars to Euros where the currency exchange rate changes over time and between versions of the model
e. ownership changes, e.g. from a total Joint Venture account to a Joint Venture Partner's share where the share changes over time and between versions of the model
f. transformational changes such as the representation of a resource flow as an equivalent currency flow (through association with a resource price variable) or the transformation of one variable type under one reporting standard to two or more variable types of a different reporting standard

In one embodiment each translation object is associated with an output of a respective process object to operate as an output port object operating as connection logic for connection to the input of a process object. In this embodiment, the translation object performs the additional function of connection logic.

In one embodiment the received parameters are also for instantiation of an input port object for association with an input of each process object to provide connection logic, the parameters for the input port objects are store, and the input port objects are instantiated using the processor in the implementation of the model by connecting inputs port objects of process objects to outputs port objects of process objects.

In one embodiment the input port logic defines required parameter types for the process object, and the instantiation by the processor comprises identifying input port objects with the required parameter types.

In one embodiment the parameter types comprise sets of parameter types and the identifying of input port objects comprises matching parameter type sets according to matching rules.

One embodiment provides a computer system for modelling a business operation, the system comprising an interface for receiving parameters for the instantiation of at least one process object and at least one translation object from a user, each process object comprising logic to represent a business function and having at least one input and at least one output, and each translation object comprising logic to convert the form of a parameter of a parameter type output from one process object into a required form for the parameter of the parameter type for input to another process object; a data store for storing the parameters for the at least one process object and the at least one translation object; and at least one processor for instantiating a plurality of process objects and translation objects using the stored parameters to implement a model of the business operation by connecting inputs of process objects to outputs of process objects via translation objects to form a dependency network of objects.

One embodiment provides a non-transitory storage medium storing machine readable code for controlling at least one processor to model a business operation, the code comprising code for controlling at least one processor to receive parameters for the instantiation of at least one process object and at least one translation object from a user interface, each process object comprising logic to represent a business function and having at least one input and at least one output, and each translation object comprising logic to convert the form of a parameter of a parameter type output from one process object into a required form for the parameter of the parameter type for input to another process object; code for controlling at least one processor to store the parameters for the at least one process object and the at least one translation object; and code for controlling at least one processor to instantiate a plurality of process objects and translation objects using the stored parameters to implement a model of the business operation by connecting inputs of process objects to outputs of process objects via translation objects to form a dependency network of objects.

One embodiment provides a method of modelling a business process using a computer system, the method comprising receiving parameters for the instantiation of at least one process object, at least one input connection object, and at least one output connection object from a user interface, each process object comprising logic to represent a business function and requiring at least one input and at least one output, each input connection object comprising logic to input parameters to a process object, and each output connection object comprising logic to output parameters from a process object; storing the parameters for the at least one process object, the at least one input connection object, and the at least one output connection object; and instantiating a plurality of process objects and input and output connection objects using at least one processor and the stored parameters to implement a model of the business operation by connecting inputs of process objects to outputs of process objects via the connection objects to form a dependency network of objects.

In this embodiment, the process logic is separate from the connection logic. This enables the reuse of process logic independent of connections and the reuse of connection logic without the restriction of the business processing.

One embodiment provides a computer system for modelling a business operation, the system comprising an interface for receiving parameters for the instantiation of at least one process object, at least one input connection object, and at least one output connection object from a user interface, each process object comprising logic to perform a business function and requiring at least one input and at least one output, each input connection object comprising logic to input parameters to a process object, and each output connection object comprising logic to output parameters from a process object; a data stored for storing the parameters for the at least one process object, the at least one input connection object, and the at least one output connection object; and at least one processor for instantiating a plurality of process objects and input and output connection objects and the stored parameters to implement a model of the business operation by connecting inputs of process objects to outputs of process objects via the connection objects to form a dependency network of objects.

One embodiment provides a non-transitory storage medium storing machine readable code for controlling at least one processor to model a business operation, the code comprising code for controlling at least one processor to receive parameters for the instantiation of at least one process object, at least one input connection object, and at least one output connection object from a user interface, each process object comprising logic to represent a business function and requiring at least one input and at least one output, each input connection object comprising logic to input parameters to a process object, and each output connection object comprising logic to output parameters from a process object; code for controlling at least one processor to store the parameters for the at least one process object, the at least one input connection object, and the at least one output connection object; and code for controlling at least one processor to instantiate a plurality of process objects and input and output connection objects and the stored parameters to implement a model of the business operation by connecting inputs of process objects to outputs of process objects via the connection objects to form a dependency network of objects.

One embodiment provides a method of modelling a business process using a computer system, the method comprising receiving parameters to define a new version of at least one process module from a user interface when the parameters are different than for a previous version of the at least one process object, each process module comprising logic to represent a business function and having at least one input and at least one output, each version of a said process module being immutable and the output being dependent upon the input and the version of the process module; storing the parameters for the at least one version of a said process module; and instantiating a plurality of process modules using at least one processor and the stored parameters to implement a model of the business operation by connecting inputs of process modules to outputs of process modules to form a dependency network of process modules, object modules having associated versions being identified and connected to form the dependency network.

In this embodiment, the process modules are immutable and hence if any user want to change an object a new version has to be created. The dependency network is controlled to only connect the correct versions of process object together to avoid inconsistency in parameter processing between versions. In one embodiment, multiple versions of the model are maintained in memory. While these versions may be significantly different in effect, they may only vary by a change to a small percentage of objects in the model. In one embodiment a hierarchical version control hierarchy allows the user to switch different parts of the model into different versions, which may represent for instance different combinations of planned decision, different representations of uncertainty about the world, different ways of modelling a process, versions created by different users simultaneously, or the history of published variables over time. Using versions and labelling of version nodes, the system is able to offer the user in the user interface the ability to switch between alternative versions of the model (which versions can be loaded into memory). Then user can hence switch between them and compare multiple versions. Further, multiple users can update models on their own client machines and each user's changes can automatically be merged onto the other users machines, in order that they can compare the versions and switch between them. Users can, not only compare the parameters that define the individual process objects, but they can compare the results of different combinations of process objects.

In one embodiment, output data for each of a plurality of output cases of each version of a process module is stored in a cache as case data for use when the version of the object is instantiated, each output case being dependent upon different combinations of outputs of prior connected process modules. The output data can comprise multiple data parameters.

In one embodiment, each output case of each version of a process object is assigned a unique identifier and the unique identifier is stored in a data structure. The data structure can include storage with the process modules or within a separate data structure.

In one embodiment the data structure storing the unique identifier for the process objects is hierarchical and the process objects are grouped into a process component for performing a business function, wherein a version of a component is associated with a group of process objects having common parameters. This structured arrangement enables reuse of versions of process objects and hierarchical management of cases of model results.

In one embodiment the new version of the process object is determined to be formed based on new user, time or a change in business assumptions, parameters, or decisions.

One embodiment provides a computer system for modelling a business operation, the system comprising an interface for receiving parameters to define a new version of at least one process module from a user when the parameters are different than for a previous version of the at least one process object, each process module comprising logic to perform a business function and having at least one input and at least one output, each version of a said process module being immutable and the output being dependent upon the input and the version of the process module; a data store for storing the parameters for the at least one version of a said process module; and at least one processor for instantiating a plurality of process modules and the stored parameters to implement a model of the business operation by connecting inputs of process modules to outputs of process modules to form a dependency network of process modules, object modules having associated versions being identified and connected to form the dependency network.

One embodiment provides a non-transitory storage medium storing machine readable code for controlling at least one processor to model a business operation, the code comprising code for controlling at least one processor to receive parameters to define a new version of at least one process module from a user when the parameters are different than for a previous version of the at least one process object, each process module comprising logic to perform a business function and having at least one input and at least one output, each version of a said process module being immutable and the output being dependent upon the input and the version of the process module; code for controlling at least one processor to store the parameters for the at least one version of a said process module; and code for controlling at least one processor to instantiate a plurality of process modules and the stored parameters to implement a model of the business operation by connecting inputs of process modules to outputs of process modules to form a dependency network of process modules, object modules having associated versions being identified and connected to form the dependency network.

One embodiment provides a method of building a model of a business operation using a computer system, the method comprising receiving parameters for at least one business factor from a user interface, the business factors representing an entity, an activity, or a product associated with the business operation; storing the parameters for at least one business factor; instantiating business objects using at least one processor and the stored parameters to form a dependency network of business modules to determine conformance to requirements in a stored data structure; receiving parameters for at least one process module from a user interface, each process module representing an element of the business process using or relying upon the business factors and having at least one output port and at least one input port; storing the parameters for the at least one process module; instantiating a plurality of process modules using at least one processor and the stored parameters to implement a model of the business operation by connecting inputs of modules to outputs of modules to form a dependency network of process modules.

In this embodiment, when a user created a new business function, such as an entity, a product, an activity or a variable, the entered parameters are checked for consistency with the data structure defining the framework of the model using a dependency network. The model hence defines a two layer dependency network.

One embodiment provides a computer system for building a model of a business operation, the system comprising an interface for receiving parameters for at least one at least one business factor from a user, the business factors representing an entity, an activity, or a product associated with the business operation; a data store for storing the parameters for at least one business factor; and at least one processor for instantiating business objects using at least one processor and the stored parameters to form a dependency network of business modules to determine conformance to requirements in a stored data structure; wherein the interface is for receiving parameters for at least one process module from a user interface, each process module representing an element of the business process using or relying upon the business factors and having at least one output port and at least one input port; the data store stores the parameters for the at least one process module; and the at least one processor is programmed to instantiate a plurality of process modules using at least one processor and the stored parameters to implement a model of the business operation by connecting inputs of modules to outputs of modules to form a dependency network of process modules.

Another embodiment provides a non-transitory storage medium storing machine readable code for controlling at least one processor to model a business operation, the code comprising code for controlling at least one processor to receive parameters for at least one business factor from a user interface, the business factors representing an entity, an activity, or a product associated with the business operation; code for controlling at least one processor to store the parameters for at least one business factor; code for controlling at least one processor to instantiate business objects using at least one processor and the stored parameters to form a dependency network of business modules to determine conformance to requirements in a stored data structure; code for controlling at least one processor to receive parameters for at least one process module from a user interface, each process module representing an element of the business process using or relying upon the business factors and having at least one output port and at least one input port; code for controlling at least one processor to store the parameters for the at least one process module; code for controlling at least one processor to instantiate a plurality of process modules using at least one processor and the stored parameters to implement a model of the business operation by connecting inputs of modules to outputs of modules to form a dependency network of process modules.

In one embodiment, each object in the model defines its own dimensions (parameters) which are consistent with the data structure defining everything required in the operation of the business i.e. entities, products, parameters and activities. The definition of the dimensionality is provided by the data structure which is defined and input by a user. The objects confirm to this data structure and hence their dimensions are independent of prior object outputs in a dependency network of objects.

By combining the modelling and management of activities and decisions together with technical and commercial modelling the system can help businesses for example by:
1. Enabling decision-makers to optimize project development by performing technical reviews resulting in recommendations for contracting strategy and project management systems.
2. Quantifying expected returns on an asset, or group of assets, by modelling each asset in detail to perform rigorous technical and commercial valuations.
3. Enabling decision-makers to model the economics of integrated projects (e.g. operations by an Independent Power Producer (IPP), Liquefied Natural Gas (LNG), refining, in the oil industry, from reservoir through to delivery point.
4. Quantifying potential project risks and rewards by performing deterministic and probabilistic risk analysis and post-tax project economics.
5. Preparing companies for negotiations by providing a technical review of third-party contracts
6. Optimize physical infrastructure arrangement in order to maximize returns and minimize costs

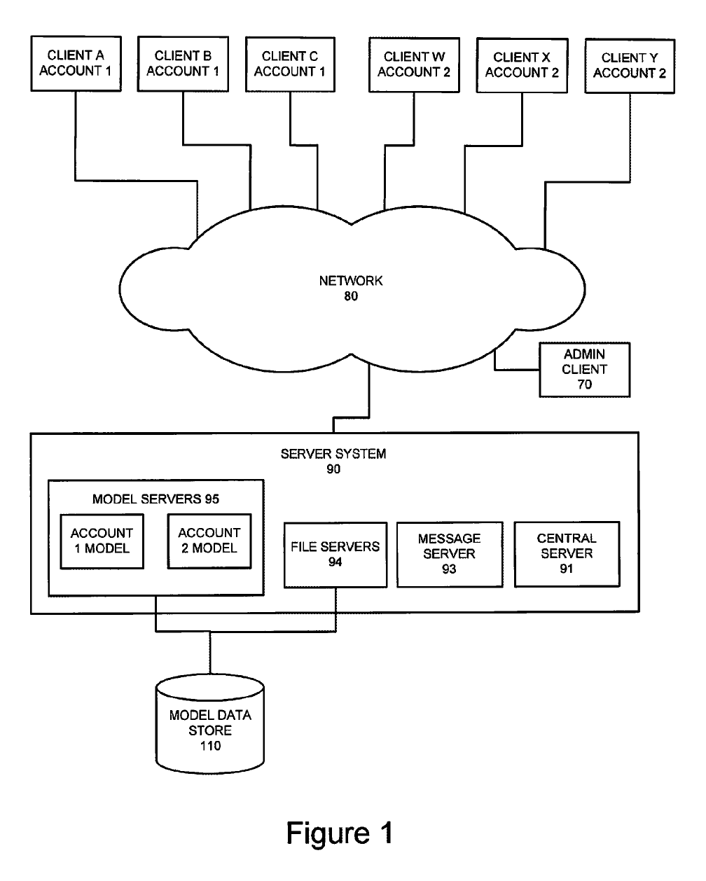

Referring now to the drawings, FIG. 1 illustrates a computer system according to one embodiment for implementing the business modelling.

Client machines for groups of users are connected via a network 80 to a server system 90. Also an administrator client 70 can be provided connected to the network 80 to connect to the server system to perform administrator functions.

The server system 90 comprises a number of interconnected servers. Model servers 95 access the model data store 110 to implement the models, although the models can also be implemented at the clients. The data defining the models stored in the model data store 110 can comprise structure data such as XML. In order to implement a model using the XML data, the model servers 95 use a computer language such as C++ to create the objects from the data set for execution. File servers 94 are provided to store the results of executions of the models and cached object definitions developed by users to be available to users. A central server 91 is provided for interaction with clients to receive and store any changes in models. A message server 93 is provided for the sending and receiving of messages e.g. structured messages, to and from the clients. For example, clients may be notified when new objects are available.

FIG. 1 illustrates the model servers 95 implementing two different model accounts for two different accounts access by two different groups of user on client machines. Client machines A, B and C access the account 1 model and client machines W, X and Y access the account 2 model. For a single organization, one model can be used because anything can connect to anything. The multiple accounts for the organization are within the model. A user can load a number of accounts, as will be described herein.

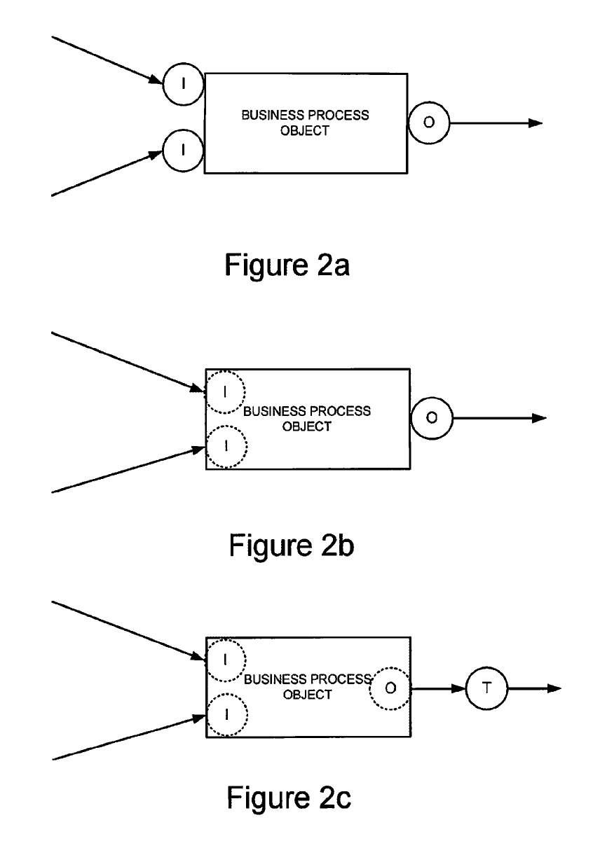

FIGS. 2a, 2b, and 2c schematically illustrate business process objects instantiated according to different embodiments of the invention. In all these embodiments, the business process object defines logic for performing a business process such as calculate a time-varying profit for a business unit, or the production output of an oil well again varying over time but possibly also by vertical depth. The embodiment are illustrated as having two inputs to the business process logic. However, any number of inputs can be required by the business process object. The inputs of objects can be connected to the outputs of objects to form a dependency network.

FIG. 2a illustrates an embodiment in which a business process object is instantiated as process logic separate to input objects I implementing input connection logic, and output objects O implementing output connection logic. The connection logic is required at the input and output of the business process object to form connections between business process objects in order to form a network of business process objects. This network comprises a dependency network since the input of modules is dependent on the output of prior connected modules in the network. This embodiment enables the input and output object and the process object to comprise logic which can be reused more easily because the connection logic is not conditional on the process logic and vice versa. The input logic can define the requirements for inputs to the process object. As will be described herein after the requirements can be defined by labels, which the outputs of prior output objects must match. The input logic provides the output of the process logic and performs connections with input objects when the requirements match. The output object can also include logic for transforming the output parameters of the process object to the form required by the input objects of dependent process objects. The parameter requested by the input object for a dependent process object can for example be ‘oil flow’ in the units of energy (kJ) as defined in the label of the input object. The output of the process object for ‘oil flow’ in the units barrels per day. The transformation logic of the output object can operate to convert the form of the ‘oil flow’ parameter to convert the units to kJ for the dependent process unit. The transformation performed by the output logic can comprise:
a. unit changes such as imperial to metric
b. unit transformation e.g. units of volume of oil converted to equivalent energy or mass units
c. scale changes e.g. in the time dimension, from irregular to regular divisions, or separately or in combination in a local along road dimension from divisions in 10 of meters to divisions at road junctions
d. currency changes, e.g. from Dollars to Euros where the currency exchange rate changes over time and between versions of the model
e. ownership changes, e.g. from a total Joint Venture account to a Joint Venture Partner's share where the share changes over time and between versions of the model
f. transformational changes such as the representation of a resource flow as an equivalent currency flow (through association with a resource price variable) or the transformation of one variable type under one reporting standard to two or more variable types of a different reporting standard

FIG. 2b schematically illustrates an alternative embodiment of the invention in which the output object remains as described with reference to FIG. 2a but there are no input objects. In this embodiment, the business process object includes its own connection logic for input port I. This reduces the number of object required. It does however reduce the flexibility of the object configuration and logic reuse. The configuration of objects of this embodiment can be used in a model with the configuration of objects of the embodiment of FIG. 2a.

FIG. 2c schematically illustrates an alternative embodiment of the invention in which the business process object includes both input connection logic and output connection logic. A transformation object T is provided to implement transformation logic for the transformation of the form of parameters required as inputs of dependent process objects and as described with reference to FIG. 2a. The configuration of objects of this embodiment can be used in a model with the configurations of objects of the embodiments of FIGS. 2a and 2b. The transformation object can be dynamically configured or instantiated as required. A transformation object can be assigned or created only for instances of connections between inputs and outputs where transformations of the outputs of process objects is required to meet the requirements of the inputs of dependent process in the dependency network. The inputs and outputs of objects can be multi-dimensional and hence the parameters of only one, some or all dimensions may require translation. The translation object can comprise one object per dimension, in which case multiple transformation objects may be required for multiple dimensional outputs and inputs, or a combined multi-dimensional transformation object can be instantiated for the connection.

Although in FIGS. 2a, 2b and 2c only one output object is shown for the business process object, any number of output objects can be provided for each business process object to provide any number of outputs, which can be matched and connected with one or more input objects of other business process objects. Each business process object can have any number of input objects associated with it for receiving any number of inputs: each input object matched and receiving outputs from one or more output objects of other business process objects.

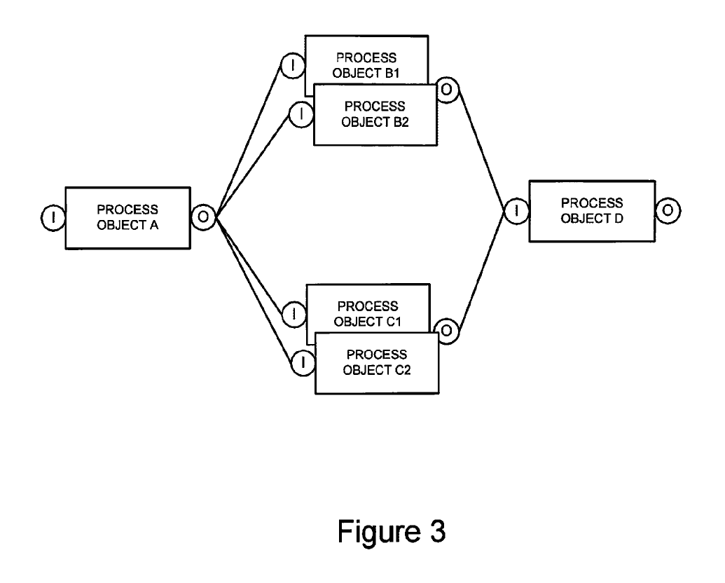

FIG. 3 is a schematic diagram illustrating a network of four process objects with their associated connection objects (I and O) in which the network can be implemented with two different version sets of process objects. FIG. 3 illustrates for example the process objects in a network for the performance of a business component. The required result is the output of process object D. Process object D is dependent upon the outputs of process objects B and C, which in turn are both dependent upon the output of process object A. Process objects B and C exist in two versions B1 and B2 and C1 and C2. In order for the processing by process object D to be correct, the correct versions of process objects B and C must be selected which are consistent with one another i.e. they both rely on the same business conditions or factors. Factors impacting on the requirement for new versions of objects will be described herein after.

As shown in FIG. 3, each version of the same process object (B and C) share the same output port. The output port contains the logic to control the selection of the correct version of the process object required to provide the input for the requesting input object. Hence, the output objects act as switches to switch in the correct version of the process object. This results in the process object D having a number (four in this example) of possible outputs or versions of outputs termed cases, namely B1C1, B2C1, B1C2 or B2C2. Hence, different combinations of versions of process object generate different results cases. As will be described hereinafter, the results of the processing of each output can be cached for each case to avoid the need to recalculate the same values again to speed up processing. The output port associated with each respective process object manages the caching of cases. Each case is identified or labelled with its processing object version dependency to enable easy identification. Alternatively, each case can be labelled on a version hierarchy structure as described herein after. This allows the ease of switching in memory between different versions of objects and between cases. The output data of each object can comprise any number of variables or parameters e.g. financial parameters (price, profit, turnover, tax), production parameters (flow, density), physical parameters (depth, strength) and can be defined to vary along one or more dimensions (e.g. time, depth, region). Hence, the output data of each process object can be multi-dimensional, leading to the cached data for each case for the model of objects in the dependency network comprising a multi-dimensional array.

A process object can produce multiple outputs. In general there is a cache for each output, although there may only be one output for one or more objects. Further, the caches could be combined.

It is not sufficient to cache results for the versions of the process object. Because the process object is in general part of a dependency network, its results depend on the results of prior process objects in the dependency network. For instance if Object C depends on Object B which is an input to the system and each of C and B has two versions denoted C1, C2, B1, B2, then potentially C has four versions of its results (we call these Cases), C1 B1, C1 B2, C2 B1, C2 B2. In another example if C still depended on B but B was a process object that depended on an input object A that itself had 3 versions, then there would potentially be 6 Cases of B (2 times 3) and 12 Cases of C (2 times 2 times 3).

It can be seen that in a model with a long dependency chain or for objects such as consolidation objects that depend on many other objects, the total number of potential Cases for the results of a process object can grow to be very large.

Fortunately a user will not normally wish to explore all possibilities and will only wish to explore certain combinations of objects. To control the potential explosion of Cases the versions of sets of objects are combined on a version hierarchy. Users will normally select versions of the model to view by selecting alternatives on the version hierarchy dimensions

The caching is normally on demand, and a Case is stored as it is calculated.

An output port may store its cases in terms of its precedent input modules, or in terms of the versions of higher level nodes on the version hierarchy. The advantage of storing in terms of precedent modules is that Cases of the results of a process object may be reused in multiple versions of the module without the need for recalculation. However, if there are a large number of precedent modules the burden of managing and interpreting the Case labels may outweigh the advantages in saving calculation. Where a module has a small number of connections the system will choose to cache in terms of case labels (unique identifiers for cases) of the independent precedent modules. Where there are a large number the system will normally choose to describe and store the cases in terms of the version dimensions. However, on occasion it may choose to store in terms of the account or component level on the hierarchy (as discussed herein after). The decision on when to switch from low-level description to high level description will depend on the topography of the model and is a tunable parameter within the model and may vary for different parts of the model.

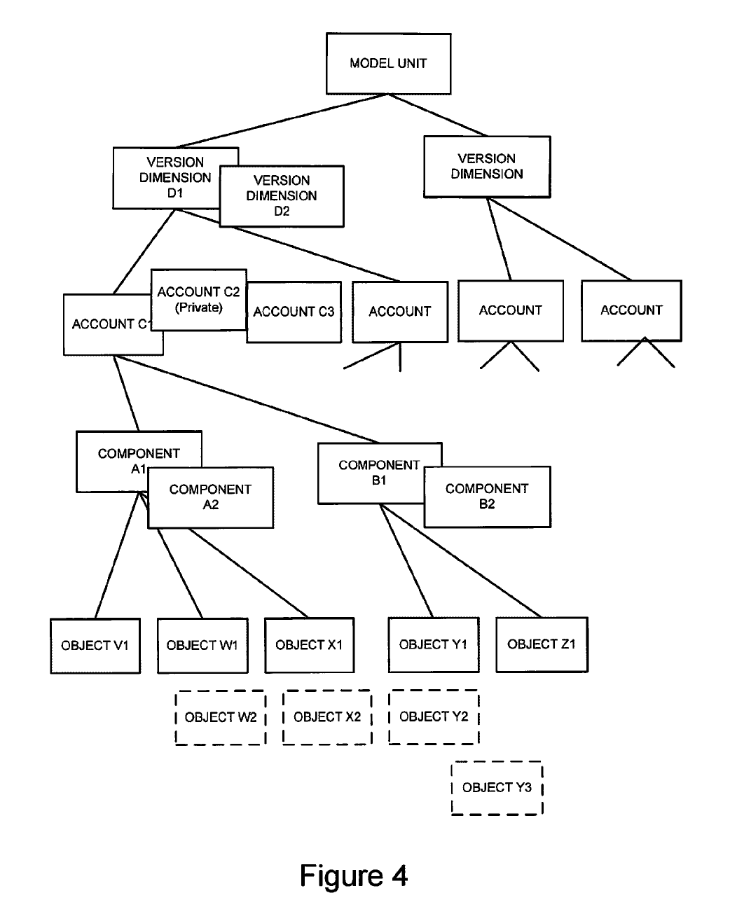

FIG. 4 is a schematic illustration of the data structure used for version management and control for objects. The hierarchical structure enables the reuse of objects in different versions.

A data structure, which in this embodiment comprises a hierarchy, is used for version control of objects this has the effect of reducing the potential explosion of cases of the model, provides a mechanism for distribution of work between users, and provides a mechanism for efficient partitioning of the model versions. A model unit is defined in which consistent model structure definitions must be used as will be discussed herein after. Within a model unit a user entity can define different version dimensions of the model to be used and can define alternative versions on each dimension, each version being a combination of the versions of the objects that belong directly or indirectly to the dimension on the version tree The different versions can be due to, for example, different parameters, variables and decisions by the business. For example, a business may wish to model and compare on one dimension (the Decision dimension) the combinations of current decisions to drill for oil in different oil fields. The selection of these decisions causes new objects and versions of object to be used to model the business operations resulting from the business decisions. At the same time the business may wish to model on a separate version dimension (the Scenario or uncertainty dimension) different values and model objects defining the possible combinations uncertain parameters, including the amount of oil (reserves) in the oil fields, the cost of the wells and the price at which the oil can be sold. The business may further wish to investigate different policies for making future decisions on yet another version dimension, the Policy Decision. The number of version dimensions is not limited and in general, there will be a plurality of version dimensions for instance a dimension may be defined for the each of a business's competing businesses' decisions and for the decision of each government that has an influence on the businesses operating environment.

The data structure then defines accounts below version dimensions. Each account can be accessed and managed by a group of users. Each account has a plurality of components A and B. Each component represents a component of the business operation that generates one or more output parameters. Each component comprises a plurality of process objects and associated input and output ports. Versions of process objects and output port objects are managed in the data structure as belonging to or having an association with a version of a component. In the embodiment of FIG. 4, component version A1 has associated with it object versions V1, W1 and X1. Component version A2 has associated with it object versions V1, W2, X2 and Y2. Component version B1 has associated with it object version Y1 and Z1. Component version B2 has associated with it object versions Y3 and Z1. Hence, it can be seen that the structure allows for the reuse of object versions by different component versions, and that the design is recursive, in that Account versions can reuse versions of components and likewise dimension versions can reuse versions of accounts. As illustrated account versions C1 and C3 each use component version A1 while using component versions B1 and B2 respectively. Further, versions of account or component nodes can be maintained by a user entity or a group of user entities as a private version unconnected to a parent node, these can be switched into the model by the owning user entity of group of user entities in order to see the effect of this combination of versions of the objects, on the overall model results. Also, although the structure within a selected version of the model can be seen to be hierarchical, because component version A2 has associated with it a version of object Y (Y2) from component B, when multiple model versions are present, the hierarchical structure can become intertwined through reuse of objects between versions and hence in general forms a set structure or more specifically a semi-lattice. While a four level hierarchy is shown in this embodiment, other embodiments may utilize a reduced or increased number of levels on the dimension according to the purpose of the model and in the reductive case may reduce to a single level.

Each object version has a unique identifier (ID). The object version is immutable and hence the ID must be unique for an object version. In one embodiment, each process object has associated with it one or more output objects and zero to many input objects. The use of separate logic for processing and connections enables the same object classes to be used again with unique instantiations for each version of the model unit.

When a processing object in a model is instantiated it processes data parameters to generate output data. Since the processing object may be dependent on a large number of objects, each possibly having multiple versions, each object can potentially have a very large number of possible versions of its output data, these versions are known as cases. Where an object has a small number of dependent objects the possible cases of its output data may be significantly less than the number of versions of the model, and many model versions may use the same case of an object. An output port may be set to cache results from its processing object when a request from a dependent object or the user entity through the user interface requests it to calculate in a particular version of the model, an output port that is set to cache will check its cache before calculating to see whether the case has previously been calculated and if so will return the cached results.

For the purpose of collaborative modelling and model distribution across processors and computers, the output ports from an account or model unit, the Public (those visible outside an account or model unit) output ports will normally be cached to disk. This facilitates the system being able to load just the output ports of precedent processing objects in upstream accounts or model units (where there is no cross-dependency of the process objects between the account(s) being loaded and the predecessor accounts), when a user wishes to work on or review an account or model unit, this greatly reduces the amount of model that must be loaded, and reduces the amount of in-memory calculation. It can hence be seen from FIG. 4, that the data structure for the object versions becomes multidimensional with each decision creating a new version branch in the structure. The decision by the business effects policies and parameters and hence changes the required objects and object versions.

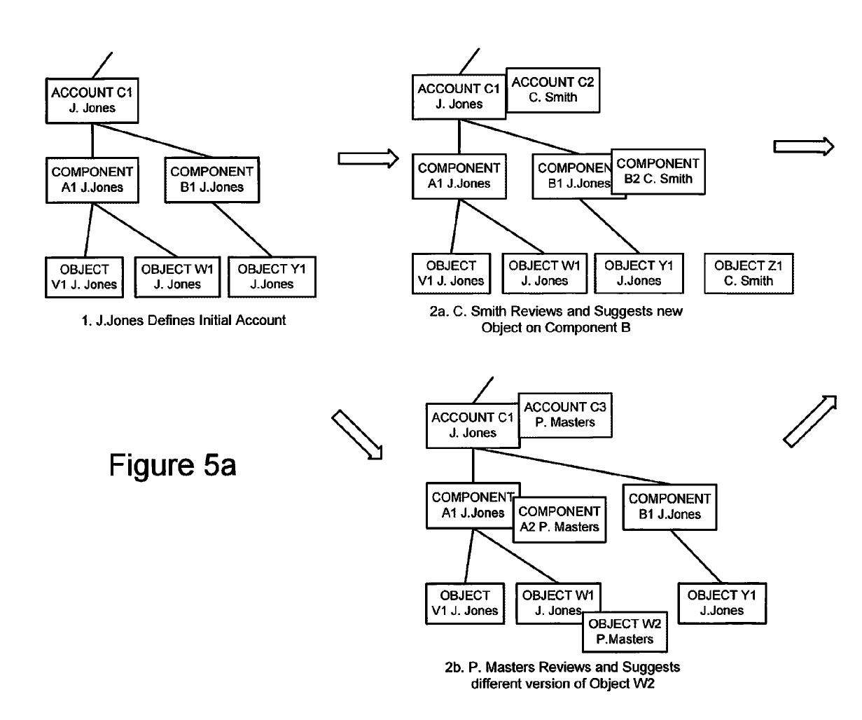

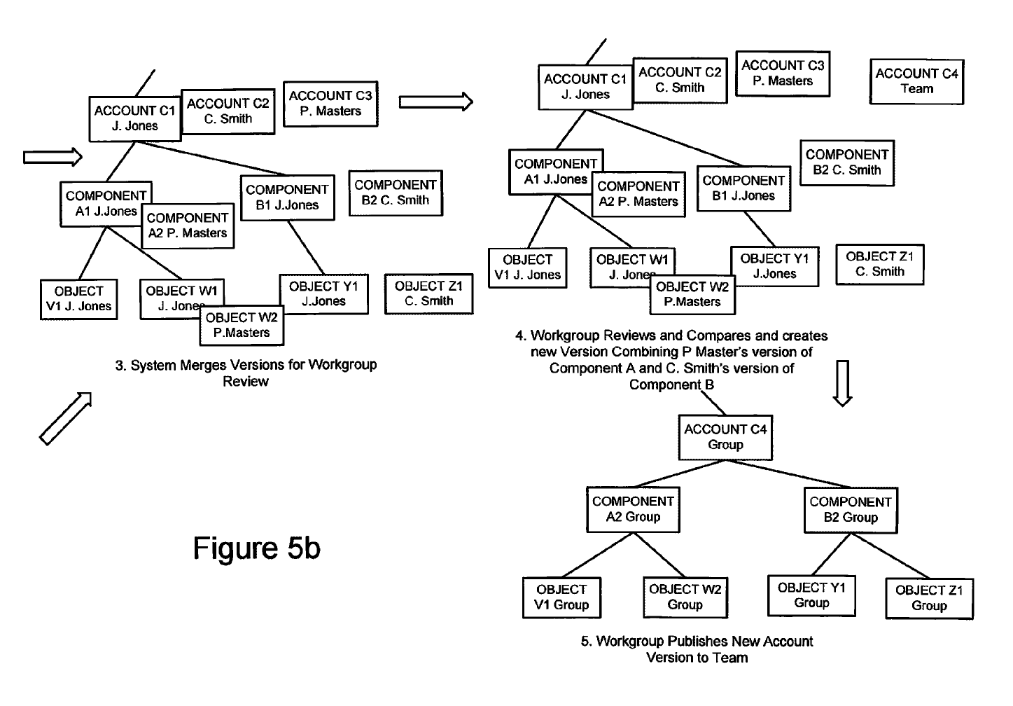

FIGS. 5a and 5b illustrate the use of the data structure of FIG. 4 in the merging of different versions for different accounts in a model unit.

An initial account C1 is defined by user J. Jones having components A1 and A2 and objects V1, W1 and Y1. Another user C. Smith reviews the account and suggests using a new object Z1 for component B1 thereby creating a new component B2 under a new account C2 for the user C. Smith, but inheriting objects V1 and W1 under component A1 and object Y1 under the new component B2. Another user P. Masters also reviews the account C1 created by J. Jones and suggests a different version of object W2 for component A1, thereby creating new component A2 for objects V1 and W2 and a new account using components A2 and B1. Because the account variables may depend on, or interact with variables in other accounts, each person's version of the account will be periodically merged with the inputs from the remainder of the model, as these are modified. FIG. 5b shows the merging of account versions C1, C2 and C3 by the 3 users. A team manager or the workgroup working together collaboratively will review the merged data and select to create a team account C4 for the workgroup comprising the users J. Jones, C. Smith and P. Masters in which the user P. Master's version of component A2 is combined with the user C. Smith's version of component B2. The group manager or the workgroup by a process such as voting will then publish the new account version to the next level in the merging process, the team level and in doing so the objects of the components A2 and B2 are denoted as being associated with the group as well as the user. The process of merging will then progress recursively through the approval levels of the model, in one embodiment each account which is the responsibility of a workgroup is merged at the model unit level by the team leader responsible for synchronising the work of the workgroups within the model unit. Normally once the team leader will submit to the “Base” model where the model unit will automatically be merged by the central server with the other model units, where the system will check for any errors and if any errors occur step back to the prior version of the system. For some model units that interact with other model units, another level of merge process may be required to ensure consistency.

In order to ensure consistency of versions across model units, the system maintains a version synchronization table, the synchronization table maps higher-level alternatives onto the alternatives defined on the version dimensions of the model units. Normally, the version synchronization table will synchronize the Decision Dimension of the business, together with the Business Uncertainty/Scenario Dimensions and the Environment Uncertainty Dimension and may also synchronize other Decision Dimensions of competing businesses that have a particularly significant influence on the business (the decision dimensions of other businesses that have a lesser effect on the business would normally be mapped onto one of the Uncertainty Dimensions).

By synchronizing the version dimensions of the model units, the system is able to compare different alternative sets of decisions about the options for the business; it can do so under different assumptions about conditions of the economic and physical environment and for different assumptions about the actions of competing businesses and of governments. Furthermore, different user entities, workgroups or teams may propose alternative models of the business and these models maybe compared with the “Base” model under the different assumptions about the sets of business decisions and the future environment. Further, since the various models can be loaded into computer memory and will normally share the vast majority of their objects under the control of a single version structure, new sets of decisions can easily be generated and their results rapidly calculated and compared under the different alternatives assumptions and for different proposed models.

Each object version together with the labels that identify the nodes on version hierarchy are immutable and stamped with their date of creation and approval on a non-transient medium, it is possible to maintain a complete record of the versions of the model, with minimal replication of data. The version structure forms a complete evolution over time of the historical and the individual user and user group versions of the model together with the “inner” versions formed by the version dimensions including where specified the Decision, Scenario and Policy dimensions. Selected historical and user and/or user group versions can be loaded into memory concurrently and combined onto a single version structure and the objects connected through the dependency network, thus creating a single integrated model incorporating the different versions, and enabling the results data of the process object output ports to be cached and compared concurrently across the historical time, user, and where appropriate, the Decision, Scenario and Policy or other defined version dimensions.

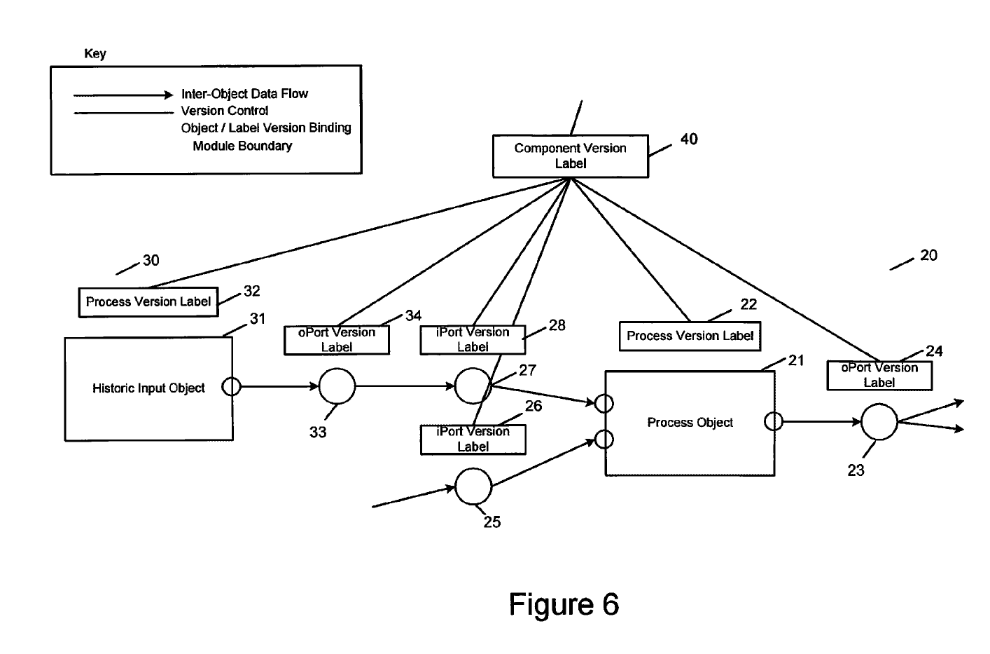

FIG. 6 is another schematic diagram illustrating version control on the objects in a dependency network. The diagram illustrates the use of version labels to link all of the objects to a component version.

A component label 40 in the data structure is associated with version labels for each of the objects. In module 30, a historic input object (having no input to it) 31 has an associated version label 32 and the output port object 33 has an associated version label 34. In the dependent module 20, the process object 21 has an associated version label 22. The output port object 23 has a version label 24 and the input port objects 25 and 27 have associated version labels 26 and 28.

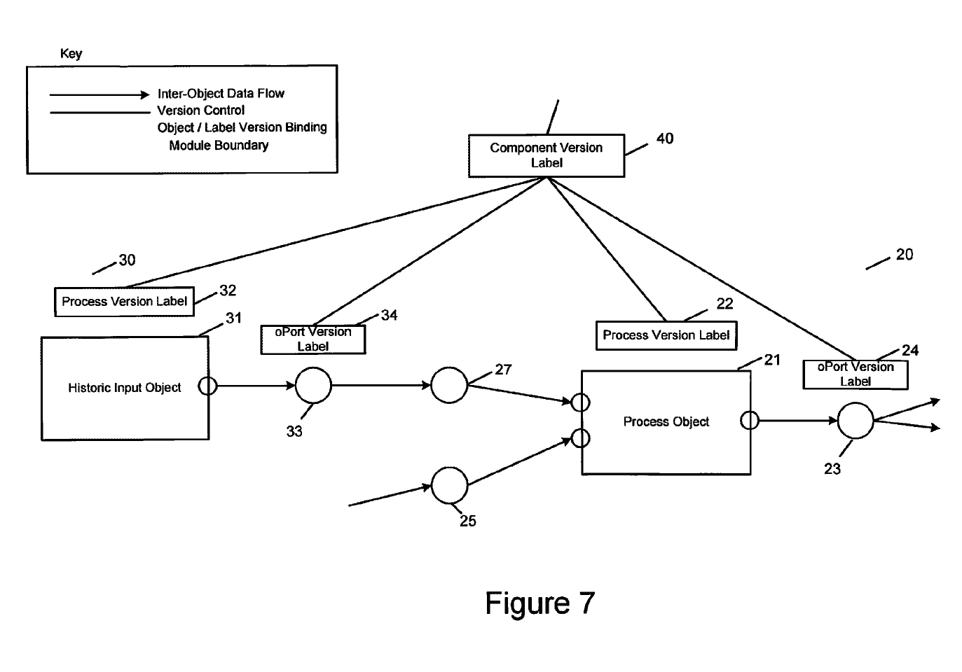

In an alternative embodiment input port objects 27 and 25 do not have associated version labels, but are linked by direct reference to the input port objects of the respective process object versions to which they relate, this reduces the complexity of the version hierarchy while still being able to share input ports between processing objects and retain their immutability. This embodiment is illustrated in FIG. 7.

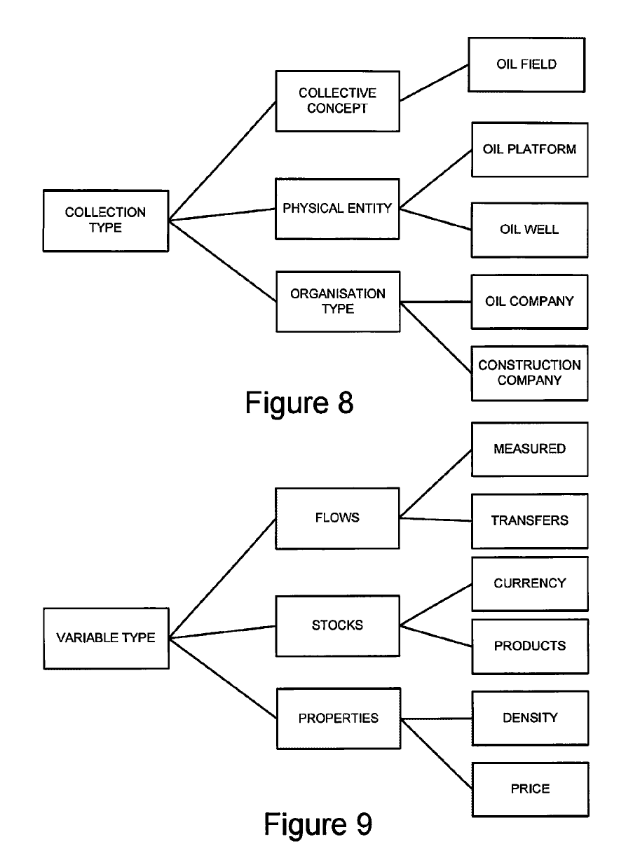

FIGS. 8, 9 10 and 11 illustrate a data structure defining business functions or assets used in the business operations.

FIG. 8 illustrates a data structure e.g. hierarchical or tree structure, for entity types. Entity types are types of things used in business. One type of entity is defined as a collective concept and an example illustrated is an oil field. Another type of entity is a physical entity and examples illustrated are an oil platform and an oil well. Another type of entity illustrated is an organization type such as an oil company or construction company.

FIG. 9 illustrates a data structure e.g. hierarchical or tree structure, for variable types. Variable types are business process variables such as physical parameters or business or financial parameters. One type of variable is defined a flows, which can be further defined as measured or transfers. Another type or variable is defined as stocks, which can be further defined as currency or product. A further type of variable is defined as properties, which is further defined as density or price.

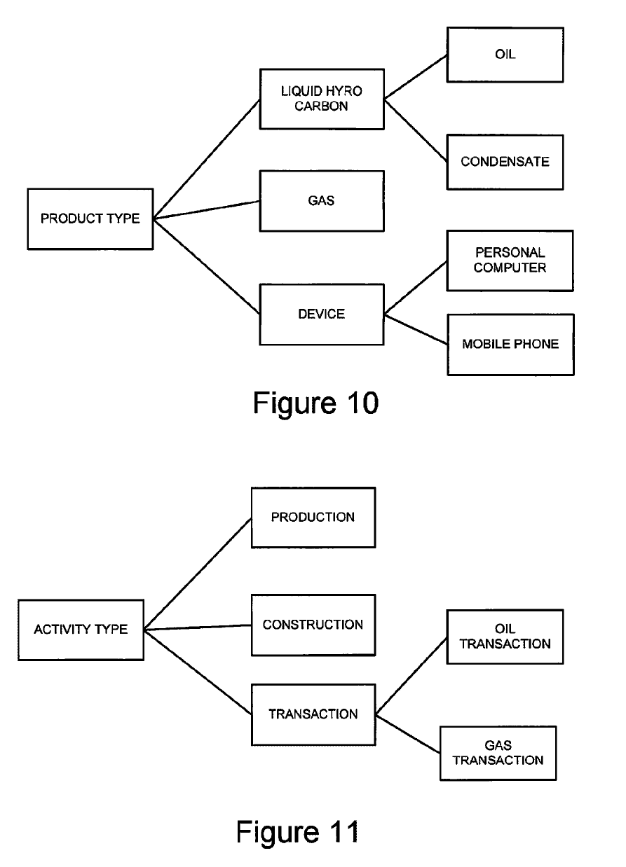

FIG. 10 illustrates a data structure e.g. hierarchical or tree structure, for product types. Product types are types of products used in the business operation. One type of product is liquid hydrocarbon, which is further defined as oil or condensate. Another type of product is gas. These are products types produced from a natural resources operation. Other products types may be manufactured products including devices which are divided into personal computers and mobile phones

FIG. 11 illustrates a data structure e.g. hierarchical or tree structure, for activity types. Activity types are types of activities carried out by or between entities and on the products in the business operation. Once type of activity is defined as production. Another type of activity is defined as construction and a further type is defined as transaction, which is further defines as oil transaction and gas transaction.

The data structures of FIGS. 8 to 11 represent the TypeStructure and define the types of entities, products, variables and activities in a business operation. New types can be defined by an administrator or the work of definition can be divided among the users of the system. A separate structure, the model structure, defines the structure of the company and their business to be mapped, the company's relationships to other entities including competing entities, governments and the physical and virtual entities it manages, and the activities and transactions of the business, its suppliers and competitors. The structure can be changed dynamically as the company and its environment changes. The data structure provides the framework on which the model objects are defined by virtue of their labels. Labels are defined on the structure by virtue of association types identifying how the object is associated to the business function defined in the data structure. Example association types are
“is Type”—indicates a direct relationship e.g. UK is a country
“belongs to”—indicates an membership relationship e.g. department X belongs to company Y
“owned by”—indicates an ownership relationship e.g. Company A owns Asset B
“acts on”—indicates an activity acts on an entity, a Construction activity acts on a Oil Platform
“is Seller”—indicates a business entity or person is the Seller in a transaction

Hence, a business can instantiate its business using the data structure of FIGS. 8 to 11 as a framework and instantiates labels which can be used by objects to define their relationship to the business function framework. The objects inherit the labels from the business functions that they relate to or use i.e. entities, variables, products and activities.

In one embodiment, both the Type structure and the model structure is described by instantiating each Type within the Type structure and each element of the model structure as a module in the system. One output object of the module provides the identity of the Type or model element by applying labels to the describing output objects of the modules, the associations to the output object of the module.

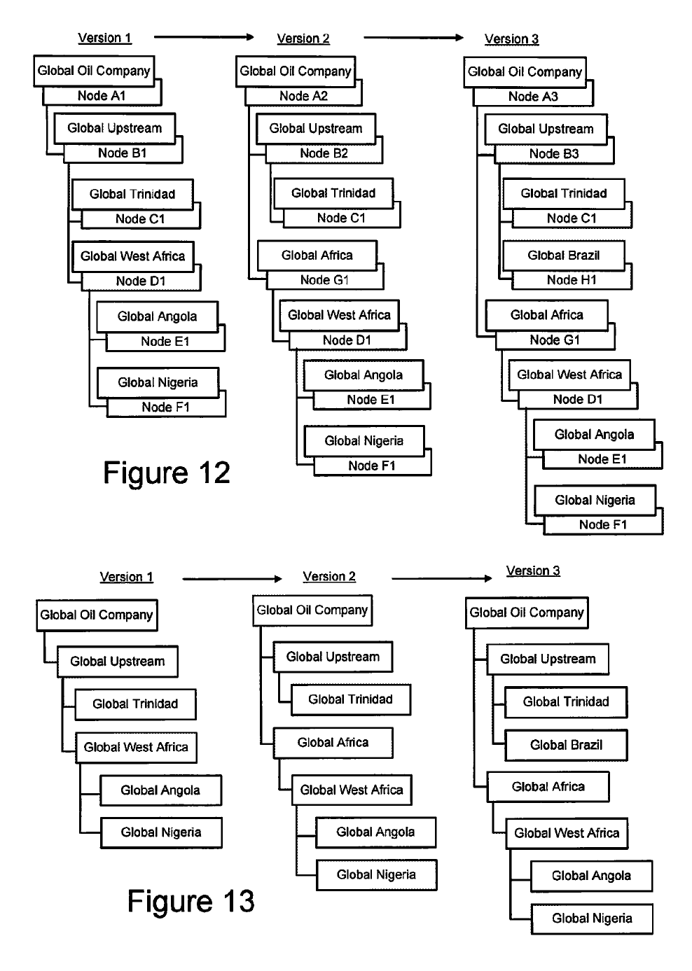

Although the labels are defined on the data structures, for speed of access and querying the labels can also be stored as data sets or in a hierarchy. FIG. 12 illustrates such a structure and shows how the structure is modified as a company structure changes.

As can be seen in FIG. 12, in version 1, a company Global Oil has defined a sub unit Global Upstream which has two sub divisions Global Trinidad and Global West Africa. Global Angola and Global Nigeria are sub divisions of Global West Africa. These are represented in the data structure as connected nodes with unique node IDs as well as the labels. In version 2, Global West Africa has been moved out from under Global Upstream and put under a new division Global Africa. The IDs of the existing nodes that's have changes indicate that the nodes are a new version e.g. Global Oil Company and Global Upstream have changed version. In version 3, a new unit Global Brazil has been added to Global Upstream. Hence, the IDs for Global Oil Company, and Global Upstream change to indicate that they are new versions.

FIG. 13 is a diagram illustrating the structures arrangement of the labels without the node IDs.

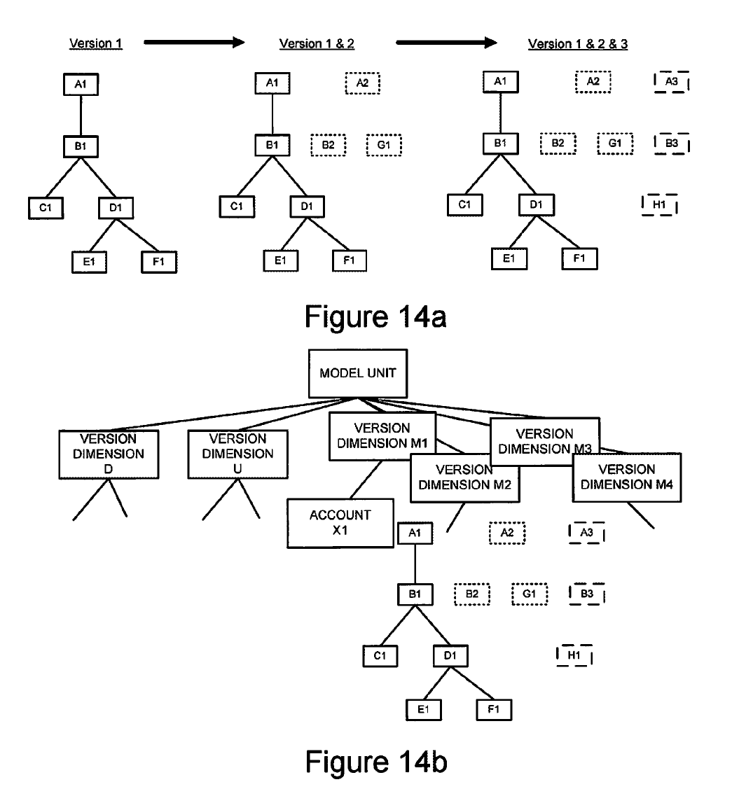

FIG. 14a illustrates the organization of the nodes IDs in the structured data to show the reuse of unchanged nodes (labels). This data structure provides for efficient data storage of the hierarchical label associations and also enables multiple concurrent alternative proposed versions (known as Options) of hierarchical structures such as organizational structures or physical structures for example, as an oilfield platform to be easily compared in the context of the model and the results used to inform decisions about which Option to select in practice When loaded in memory together the multiple versions of the hierarchy form a specific type of directed network, a semi-lattice.

FIG. 14b illustrates that the versions of the label hierarchies are mapped to the version of the model unit in which they are managed by associating the version of the root node version of the label structure to the model version dimension on the model unit version tree. This arrangement ensures that the versions of the label hierarchies are synchronized with the objects and other label structures in the model to which they relate.

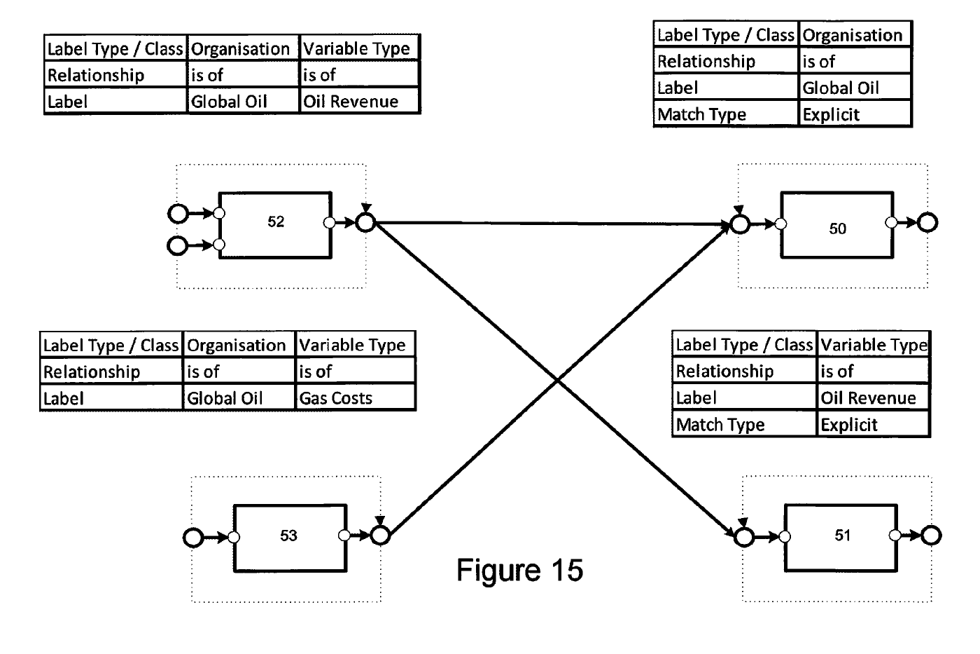

FIG. 15 is a diagram illustrating the process of label matching for explicit label matches.

In this embodiment, each label consists of three parameters, the Label Type (a set or hierarchy) the label belongs to, the association type (alternatively named relationship) and the label itself. Each of these three parameters is represented in the system as a unique ID and is immutable. The system maintains a language and synonyms table and the text shown in the User Interface will depend on the language and preferences of the User Entity. In general, an output port has a plurality of labels, FIG. 15 shows the minimum in order to illustrate the process.

In this embodiment one process object 50 requires an input labelled on its input port object as an explicit or exact match for the “Organization” “Global Oil”. The association type of the relationship between the instance of the label “Global Oil” and the label type “Organization” is “is of”. Another process object 51 requires an input labelled on its input port object as an explicit or exact match for the “Variable Type” “Oil Revenue”. The association type of the relationship between the instance of the label “Oil Revenue” and the label type “Variable Type” is “is of”.

Both of the input port objects of the process objects 50 and 51 define the matching rules for the labels “Global Oil is of Organization” and “Oil Revenue is of Variable type” as requiring an explicit match, as defined in the Match Type field.

A process object 52 provides at its output port object two labels having the label types “Organization” and “Variable Type” and associated labels of “Global Oil” and “Oil Revenue”, each label being associated to its label type by the association “is of”.

A process object 53 provides at its output port object two labels having the label types “Organization” and “Variable Type” and associated labels of “Global Oil” and “Gas costs”, each label being associated to its label type by the association “is of”.

The labels data on the input ports objects of the process objects 50 and 51 causes the system to search for matching labels according to the associated matching rule to instantiate the objects in the dependency network. In this case, an explicit match is required to satisfy the input requirements of the process objects 50 and 51. The search defined by the input port objects of the process objects 50 and 51 identifies a match between the output port object label of process object 52 and the input port object labels of both process objects 50 and 51 and hence connections are made so that the process object 52 provides input to the process objects 50 and 51. Also, a match is identified between the output port object label of process object 53 and the input port object label of process object 50 and hence a connection is made so that the process object 53 provides input to the process object 50.

For processing objects in the system, it is normal to restrict label matches on an input port to a single variable type, however where the variable types share common unit dimensions then a relaxation of this rule may be applied as illustrated above for the match on the input port of process object 50.

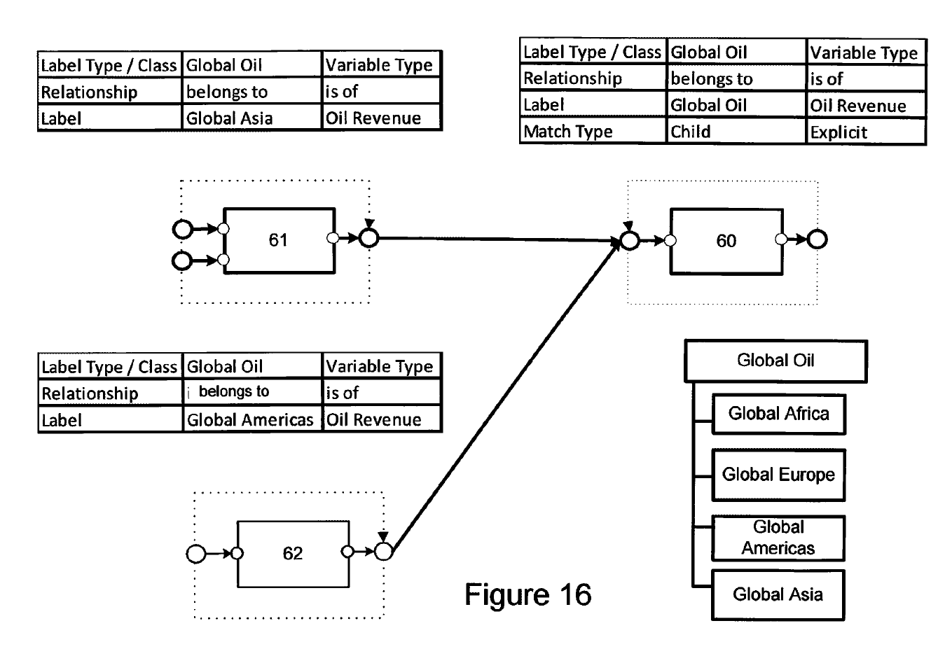

FIG. 16 is a diagram illustrating the process of label matching for implicit label matches.

In this embodiment, a process object 60 requires an input labelled on its input port object as an explicit or exact match for the “Variable Type” “Oil Revenue” and for the label type “Global Oil” the label “Global Oil” is defined by the association “belongs to” so that the matching rule is defined as “Child”. The association type of the relationship between the instance of the label type “Variable Type” is “is of”. An output object of a process object 61 has labels “Global Asia belongs to Global oil” and “Oil Revenue is of Variable Type”. Hence, the label of “Variable Type” is an exact match and as can be seen in the illustrated label hierarchy, the label “Global Asia” is a child of “Global Oil” and hence a match is identified and a connection made.

An output object of a process object 62 has labels “Global Americas belongs to Global oil” and “Oil Revenue is of Variable Type”. Hence, the label of “Variable Type” is an exact match and as can be seen in the illustrated label hierarchy, the label “Global Americas” is a child of “Global Oil” and hence a match is identified and a connection made.

The matching process proceeds through the network backwards recursively to complete the input requirements of dependent process objects for the instantiation of components of the dependency network.

In one embodiment, connections in the network include direct connections made between process objects without the use of label matching. Such connections are not dynamic or flexible and require a user to define them.

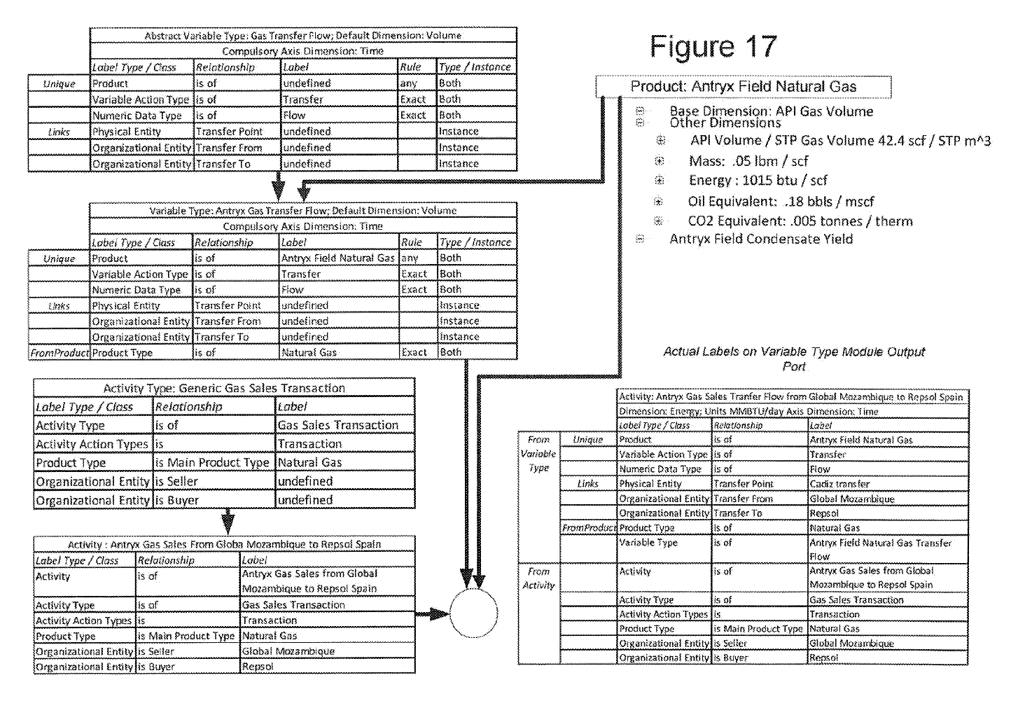

FIG. 17 is a schematic illustration of the relationship and inheritance between the structured data defining the business functions (entity type, activity type, product type and variable type) in order to define an instance of labels for an output port.

The labels on Variable Type Module Port comprise the label parameters for product “Antryx Field Natural Gas” combined with an instantiation of the “Abstract Variable Type: Gas Transfer Flow” as “Variable Type: Antryx Gas Transfer Flow”, and an instantiation of “Activity Type: Generic Gas Sales Transaction” as “Activity: Antryx Gas Sales from Global Mozambique to Repsol Spain”.

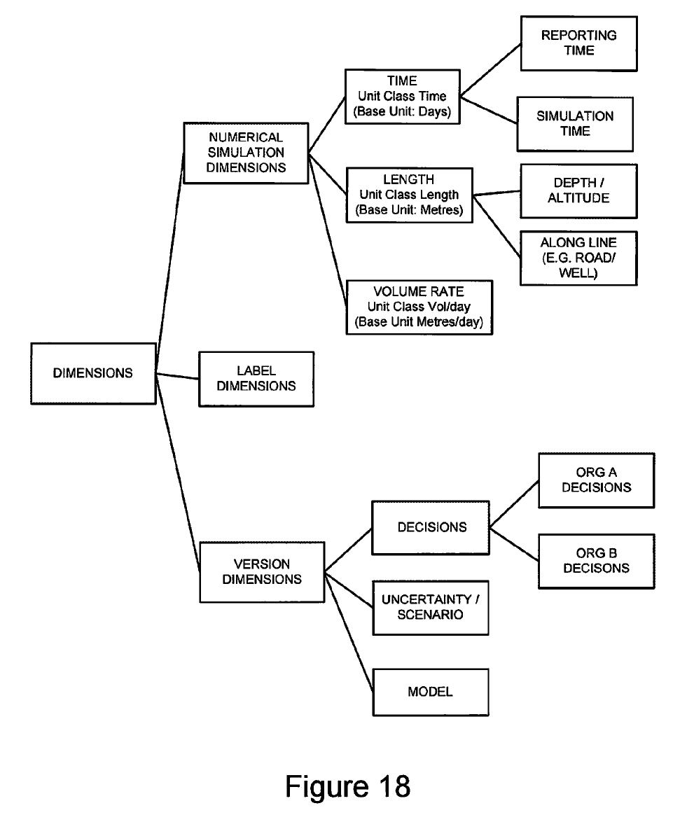

The process of transforming parameters between objects will now be described with reference to FIGS. 18 to 21.

In a multi-user collaborative environment we cannot ensure that variables are output in the form that we require them for processing. In many cases we cannot even know the form of the variables in the advance because they vary dynamically.

As an example, an organisation whose business is producing hydrocarbons may manage or participate in a number of oilfield business units in different countries that produce oil that is then taken into storage, and from time to time taken out of storage and placed in tankers for selling in the market place, the price achieved and therefore the revenue will depend on the point of delivery and the time of the sale.

Due to maintenance and other operational issues the production from each oilfield will be irregular and similarly when and how much oil is taken out of storage will depend on the availability of tankers and their spare capacity, and the revenue will be received a period of time. The organisation wishes to simulate this process for each of the oilfield business units over its life and as part of the simulation to estimate the production flow, the amount in storage, the flow into tankers and price and the revenues received over the full life of the oilfields. Further the organisation wishes to aggregate the flows, quantity in storage and revenues from all business units across the organisation.

Since each business unit is in a different country, it will work to local standards and may define the quantity of oil flowing or in storage in different units of measurement and these units of measurement might be in a different physical representation, for instance one unit may simulate a flow in volume units of thousands of barrels per day, another in Metres cubed per hour another may simulate in weight units of Tonne/day and yet another in Energy units of Gigajoules/hour. Further the currency in which each unit sells it oil will be different, and one or more of the units may be a joint venture that simulates its 100% operations but the Organisation only wishes to report its share. Various aspects of how a business unit describes its flows may change in response to its local requirements and conditions. In all cases they will simulate the flow.

Further the organisation may wish to aggregate the flows and quantity in storage and revenues from all business units across the organisation. Firstly, as the number of business units changes (through acquisitions or sale or abandonment of an associated asset) the organisation wants to automatically aggregate the simulations from the current business units. Secondly, it may want to aggregate them in its share to a particular standard for instance it may wish to aggregate production in Energy Units of MWh/day, and currency in Euros, and it will want to report the aggregation on a regular timescale that has monthly division for history and the next year, quarterly for the following two years and annually thereafter. It must do so regardless of the choice of standard made by the business units except that they must report a consistent variable type which specifies the constraints on the variable properties.

To achieve this goal, the model is structured so the output ports of a module are able to make a variety of translations in response to request from connecting processing objects via their input port for the output port to deliver its results to a particular set of standards, further an output may simultaneously receive and respond to requests from other processing objects to deliver its results to other sets of standards.

FIG. 18 illustrates a data structure for the dimensions described in the model. The model dimensions fall into three classes, the numerical simulation dimensions that are used to define the dimensions of arrays of output data from the processing objects, the label dimensions that define sets of labels that may be used to both label the objects and to define divisions of the arrays of the output data on discreet dimensions, the versions dimensions that describe the different Versions of the Model and for which different Cases of the model can be calculated since they select the versions of the model do not describe the dimensions of the variables of the Model, but can be used to describe the dimensions of post-simulation reporting variables for the purpose of comparing the results of different cases of the model on that dimension.

The system works in the following way:

Unit Conversions are defined for physical units, grouped into physical unit classes, including fundamental classes e.g. length (Base: metres) and compound classes such as acceleration (Base: m/second̂2), units can encompass other non-standard units such as man-hours and man-days

Numerical dimensions are declared that are of a numerical unit class. e.g. Time (unit class: time), Depth/Altitude (unit class: length), Easting/Westing (unit class: length), numerical dimensions declare whether they are uni-directional or bi-directional. Numerical dimensions do not have to represent rectilinear concepts they can represent such things as the distance (chainages) along a road or the measured depth along a curved oil well, and for properties such as volume rates

Offset Axes may be defined that define an Offset along an axis and a direction, these may define absolute units such as Centigrade and Fahrenheit, or for instance measurements along a road with an origin offset from the start of the road

Variables are defined as arrays that vary on 0 to n of the declared numerical label dimensions, the variable itself is also of a Dimension. In practice most model variables that are involved in the simulation, are defined solely on numerical dimensions, on occasion a variable such as a table of Tax Rate may vary on a Label dimension by for instance by Region, e.g. North and South and also by (numerical) income band on the Income Dimension. Label dimensions are most often used to describe and compare the results of the model, for instance to compare the Net Income and Cash Flow projected to results from the operations of different business units.

A variable references a Scale along each defined numerical dimension, the Scale is itself a one dimensional variable (defined along the ordinal dimension (the set of integers)) defined by a module, and its values may be calculated or input by a definer of the system, scale values must be strictly ascending. In its calculation a scale may depend for it values on the variable for which it defines the divisions, for instance the length of a time span on the time scale for loading oil into a tanker may depend on the flow rate and the amount of oil remaining in store during the time period to which the time span refers Very often in planning applications the start date of an activity's time scale will be constrained by the completion of one or more prior activities, and thus the values on the entire scale will change as the time taken to achieve the prior activities varies or as the order of the prior activities is changed.

Each variable and scale is defined in a unit and along a Offset axis of the Dimension it belongs to, most variables and scales do not have to declare an axis, they are defined on the default Offset axis with zero offset and in the forward direction of the dimensions

The scales of a variable can have regular or irregular divisions, calculated scales that represent processes and natural measurements such as the distance between sections along a road will normally have irregular divisions, that will vary according to the variations of the inputs, the number of spans on a scale may vary between simulations and the number of divisions along the scale. A scale can define a finite number of spans or an indefinite number of spans, most scales will be of indefinite length. Variables defined along a scale may be set to calculate as far in each direction as required by requests from other processing modules or may refer to separate extent modules which determine the extent of the variable along the dimension in one or both directions, and extent module may be calculated as part of the simulation. For example a variable may represent the production from a plant this may continue indefinitely but will be terminated by the abandonment of the plant, a separate calculation would determine the abandonment date which would then be used to determine the extent of the production variable which would only calculate up this extent.

The extent of variables on a dimension are propagated via output ports to variables that depend on them, in most instances this enable the downstream variables to calculate their extents without any need for their own extent variable (this is not true for variables that recurse back indefinitely along a dimension). The system defines rules for determining the extents based on the extents of the incoming variables and their Out of Extent Values. The extent of the resulting variable is the Minimum of the Minimum Extent of variables that are Undefined Out of Range (broadly Properties and Stocks) and the Maximum of the those that are Defined as Null Out of Range (Broadly Quantity Flows)

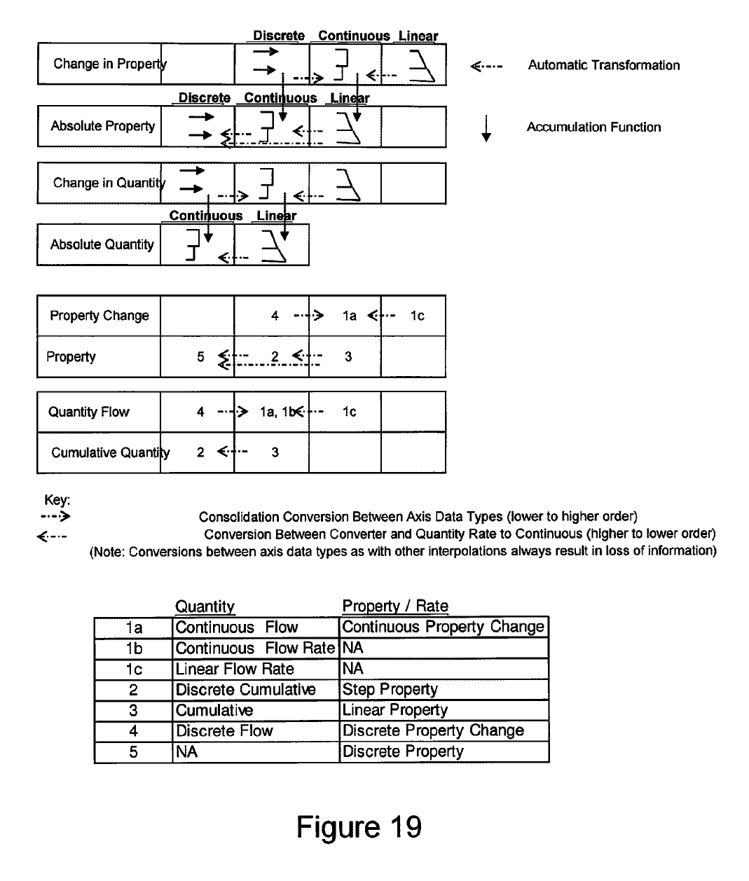

A variable must declare its Axis Data Type along each dimension, the axis data type provides the variable continuity properties on the dimension together with allowable transformations to other forms. The continuity properties, for instance, determine whether the data is assumed to be continuous (constant) between the points on the scale (this would be typical of a flow), whether the data is assumed to be discrete at the points of the scale or defined at the points on the scale and linearly varying between the points. The variable type defines the set of available Axis Data Types of the correct form and these in turn determine the available transformations. FIG. 19 shows the allowable data transformations between variables with different continuity properties. The advantage of these set of continuity properties is that they require no additional information for a variable. Other more complex continuity properties such as geometric progressions are possible within the system. However, they will normally require additional information to describe the data variation along a dimension, adding additional complexity for the user. In most cases an alternative solution is to reduce the distance between scale spans in the area of interest and approximate using a linear continuity property. Transformations between scales include a mixture of interpolation (where scale overlap) and aggregation from smaller divisions to larger divisions, while interpolations provide the desired information for reporting purposes they result in loss of information for onward interpolation. For this reason the system marks variables that are the result of interpolations and will recommend that requests for interpolation of these variables are referred to source variables. To reduce loss of data when a set of variables are brought together for the purpose of calculation that have different scales on the same dimension, at the user's request the system can transform onto a combined scale or may compose a “Lowest Common Denominator” scale which is the union of the points along the scales of each of the variables, and calculate the results of the calculation on that scale.

A separate but related system is used to define currencies and their sub-units (e.g. $ and cents), one currency is defined as a base currency and all others define exchange rates varying over time relative to this currency. The exchange rate may be calculated as part of the simulation, and may vary by version of the model

The physical unit and currency unit system is combined so composite currency and physical units can be defined, for example product price units such as Euro/M̂3, unlike unit conversion factors that are constant exchange rates are variables in the system

The system also manages estimates of future inflation for different countries and product indices, these are combined with the exchange rates to produce composite exchange rates, this enables variables to be defined in “uninflated Currency” for a particular Base Year of estimate and then adjust to any inflated currency estimate automatically.

For joint ventures and other combined enterprises, the system defines sharing agreements which define how the shares of a particular joint venture are divided among the participants, and how these vary over time, the sharing agreements are variables in the system. Variables that relate to the joint venture reference a sharing agreement and may convert from the joint venture share.

Flow and Stock variable types may allow a user to define a variable in different unit classes, a fluid may defined on the Mass or Volume dimension, a gas may additionally be defined on the Energy dimension and further on the Volume dimension it may specify different sets of temperature and pressure conditions.

Additional translations can be applied at an output port, another example is that a resource flow or quantity can report its effective cost or value by linking a resource price variable.

In some instances it is necessary for the system to provide transformations between variable types for instance an activity resource flow may be described as a drilling cost, however for reporting purposes for tax, the tax authorities require drilling costs to be sub-classified as tangible or intangible. To manage this, the user defines two additional variable types drilling tangible and drilling intangible costs, and an association requirement for drilling costs to “map” to these variable types. The definer of a drilling cost is then required to provide percentage mappings to tangible and intangible variable types (for instance 20%/80%, although this could vary over time). An input port requesting to match on intangible drilling costs will then match to the port, and when it asks for results to be delivered he output port will deliver only the percentage specified for intangible drilling costs (80%).

In these operations, in one embodiment the output port acts as an agent and may deliver results in different forms to many downstream processing objects. The process that is followed is:

An input port queries the system for label matches, it links to output ports that match the query. In a different version of the model some of these output ports may have been withdrawn, and others may be introduced each may be defined in different combinations of forms, this will result in the output ports connecting in different versions and these may have unknown (to the output port) units and scales.

There may be a number of input ports that match to an individual output port and request results from the port.

Once a connection has been established a processing object when is required to calculate will, through its input port (or the input port itself) request values over one or more spans on the scales of dimensions for which results are requested as continuous, or discrete points on the scale of dimensions requested as discrete. It will also ask for those results in a particular unit and/or currency according to the restrictions of its variable type, for quantities (stocks and flows) of products the units requested may be of a different dimension (as defined on the variable type) to the results on the output port, the request maybe for a particular company's share. The input port will normally also request the extents of each output port on the each Dimension it requests. In some of instances, in particular for product flow and revenues instead of requesting the variable it will ask for the effective revenue or value for which the output port will refer to an effective price variable.

Once the output port has received a request from the input port, it will first transform the units of the ranges requested on each dimension, if they are different from the units of the scales it uses, it will then look to its cache to see if the results for the ranges specified are available, if not it will request values from its processing object which will in turn request results via its input ports to output ports it depends on. This recurses to the start of the dependency chain whence data is returned and processed until it is delivered to the output port.

Once the data is delivered the output port will make the necessary transformations:
1. if it required to transform units it will make a call to the unit manager providing the input and output units
2. if it is required to transform along one or more dimensions it will call the necessary transformation procedures
3. if it is required to transform between currencies it will query for the relevant exchange rate variables of the input and output currencies, request values from these over the appropriate range and transform between the two currencies
4. if it is required to transform to a particular owner's share it will query for the variable that defines the ownership of that Owner for the venture it belongs to and, connect to that sharing variable ask for its values over the required range and transform to that Owner's share
5. if the variable is a product or resource and it is required to transform between unit classes it will query and connect to the relevant “Coercion” variables—these are the variables that define the transformation coefficient such as Mass/Volume and Energy/Volume for the product or resource and connect, request values and transform
6. if the variable is a product flow or stock and if the output port is requested for its equivalent revenue or value then output port will query for the effective price for the product, connect and request the price over the range and make the transformation
7. if the request is to map to a different variable type than the output ports fundamental variable type, then the output port will adjust the value by the appropriate mapping factor
8. if the request is for less dimensions than the variable has, the output port will dependent on the axis data type along the dimension of its variable either sum across the dimension or average across the dimension
9. if the input port requests the variable extents across one or more dimensions the output port returns them in the unit requested

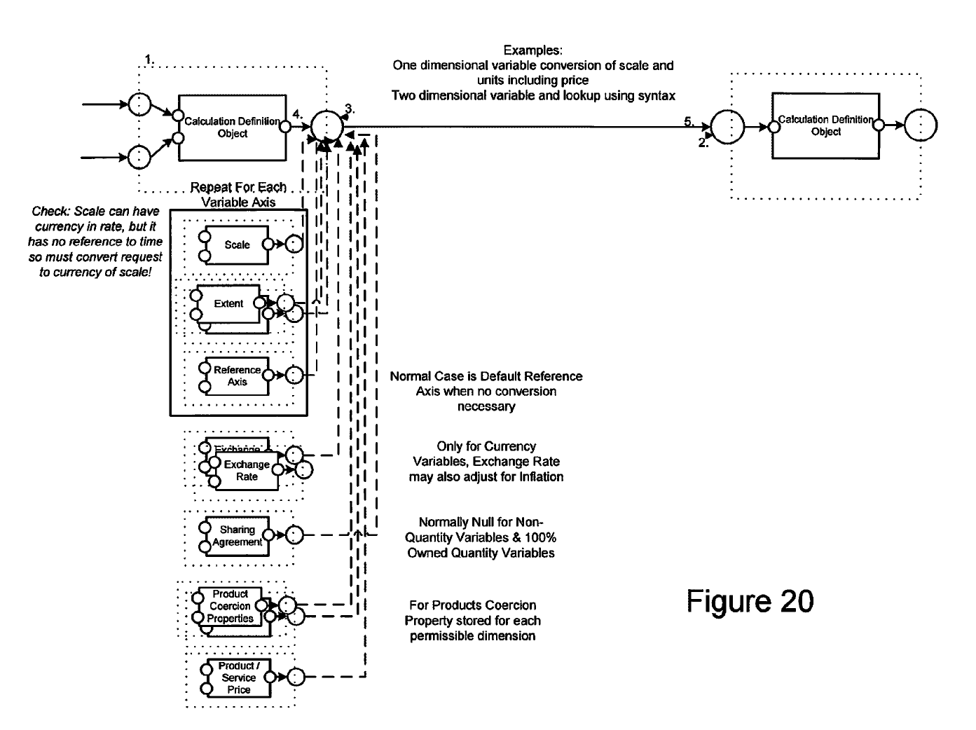

FIG. 20 illustrates one example of the transformation process. The process comprises the steps:
1. New variable component is added to system, the output port is labelled in conformance with schema, context and user input if required.
2. Either in memory or on check-in to the central server, the input port query matches labels of output port and connects to port
3. During simulation, the input port requests values for one or more cells on the scale used by the module to which it belongs output port specifying range of cells on each dimension (if different scale to output port), required units/currency, if shared quantity the owner's share and if a product the required dimension (must be consistent with units) including option of revenue
4. Normally a request is for “current” case as defined by the current setting of the version hierarchy, or for a specific case as specified by the port (post-simulation objects only).
5. If the cache for requested cells and case is empty, the output port requests that its associated definition object calculates cells for the case and the result is stored in cache (when available) on the Output Port, if the value already exists go to step 6.
6. The output port returns values over requested range(s) on each axis, in units/currency requested and in requested owner's share. If the requested range is out of extent, the output port returns the appropriate out of extent value

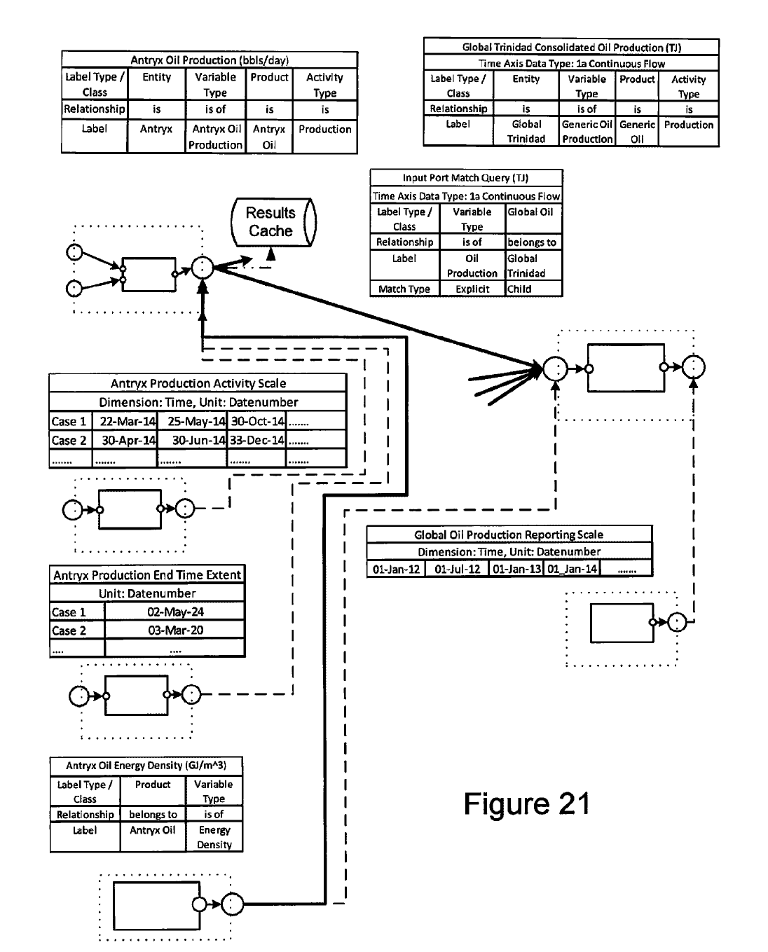

FIG. 21 is a schematic diagram illustrating the process of transformation of parameters between process objects.

A new variable type Antryx Oil Production is added to the entity Antryx, this is labelled accordingly and named Antryx Oil Production. The variable produces a Product “Antryx Oil” who's properties are defined by the Antryx Oil Product sub-model

According to the schema the variable Type Oil production can take two dimensions, Volume and Energy Density (in reality there will probably be more, e.g. Mass, CO2 equity), the variable is defined in Volume units per day, in this case Barrels per day, since the system allows “flow” variables to be defined as a “rate per unit” along the dimension of one of its axes, in this case Time, but in other examples could be for instance per metre on the depth dimension

Since input ports may ask for the variable in either dimension the output port must connect to the Coercion variable from Volume to Energy, the Energy Density (since Volume is the “Hub” dimension), it does this by issuing a label matching query for the output port having exact matches to the triples, Product:belongs to:Antryx Oil and Variable Type:is of:Energy Density (Label Type/Class:Relationship:Label). Since this is a permanent connection (it does not vary dynamically) the connection is instantiated on the port by marking the output port with the unique ID of the Antryx Oil Energy Density. In this example the Energy Density is a scalar variable, but may vary along any Dimension

The variable is defined on the Antryx Oil Production scale, which is a “natural” scale that varies dynamically with its inputs, including the end date of prior activities, which determine its start date and the time taken to drill wells which influences the length of the timespans on the scale. The scale varies by Case of the model.

The end extent of the variable on the Time dimension is determined dynamically and varies by case, thus this combined with the dynamic scale results the number of time spans varying dynamically by Case.

On the instantiation of the variable the system checks for label matches on label matching input ports (this takes place initially on in-memory objects and later when checked in to the server on all objects) a match is found to the Global Trinidad Consolidated Oil Production and the output port is connected to the input port, this connection is a dynamic one as it may vary by model case and new matches will be introduced as new Oil Production variables are introduced.

The Antryx Oil Production Output port stores its results in its native dimension, units and scale in its result cache (it may do so for many different “Cases” of the model, and may choose to index these Cases at a lower level on the version hierarchy for each version dimension to avoid replication).

Input ports that connect to the output port may ask for its results on any dimension that it supports and any applicable units on that dimension, and over any particular scale (or part scale) on its axes. In this example the Global Trinidad Consolidated Oil Production is defined in Energy units of TeraJoules (per scale span) and on the Global Oil Production reporting Scale which varies semi-annually for the first year and thereafter annually.

On request from the input port for a set of values for a Case of the model, the output port will access results from its cache if they are stored for the requested Case, make any necessary conversions and pass to the output port, if the result is not in the cache the output port will request results from the definition object, which will in turn make requests through its input ports to the output ports it depends on.

The output port may connect to a number of input ports and these may request their results on different dimensions, units and scales.

While this example shows conversions where a variable is defined along a single dimension/scale, an output port may convert along multiple dimensions/scales and between different scale units. Dependent on the variable type of the output port other conversions are available, by example for currency variables the system can convert from one currency to another and for quantities and currencies where the entity the variable belongs to is shared, the system can automatically convert to the Owner's share.

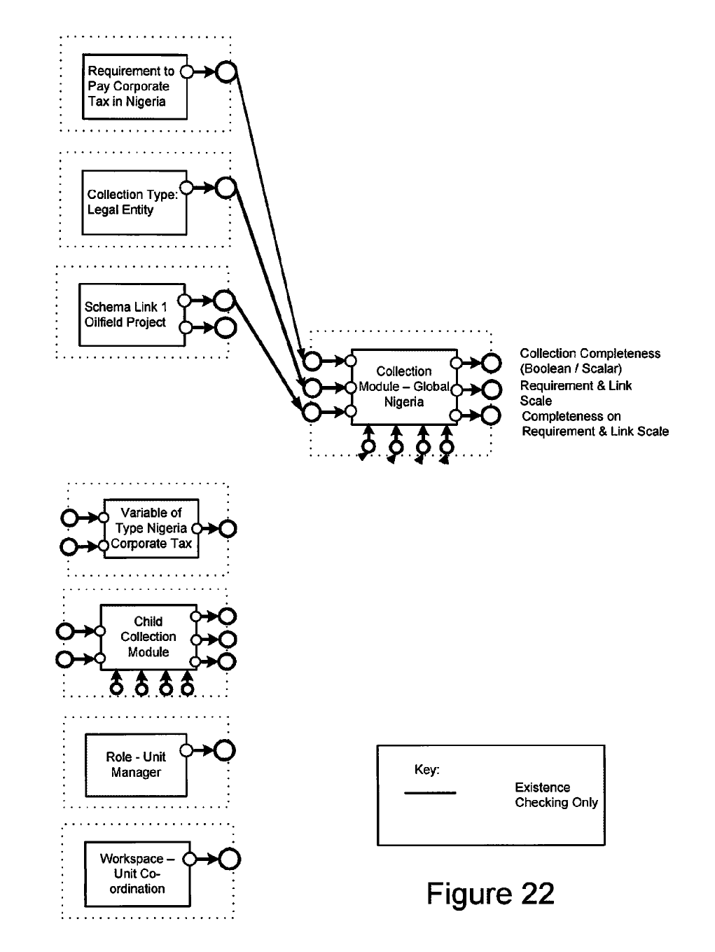

FIG. 22 illustrates the use of objects in a dependency network for the instantiation of a collection.

A collection object forms part of the model structure and represents an entity, organizational unit or activity, the collection may have a dedicated a set of variables and child collections. A collection module conforms to a collection type, which defines the rules for labelling and for instantiation of variable types, roles and workspaces in the collection, associated schema link objects define the rules for instantiation of child and related collections. The purpose of a collection module is to provide identity and context for the collection and to ensure completeness of the collection with regard to the set of requirements on the collection. In addition to its type and schema link requirements a collection module may be subject to additional requirements that are imposed from within the model, in this example the Module is instantiated as a Legal Entity in Nigeria and labelled accordingly. The collection module has two input ports that searches for all matching requirements, one that searches for requirements specifying variable type and labelling, one that searches for linked collection requirements and options. Once the collection has matched on these, it informs the user interface of the requirements and options which are presented to the used as menu options. As the user(s) builds the model, the variable types, roles, workspaces and child and related collections, these match onto input ports on the collection module, which is then able to check on the completeness of the collection against the requirements imposed on it by. The collection module then reports its completeness for the union of its requirements as a Boolean variable on an output port, on a second output port it reports a label scale of its requirements and on a third reports the completeness (as a Boolean variable on the label scale on the second port) against each requirement. A collection module that is incomplete on check-in may issue messages to the message server that will then deliver these to the responsible user(s) as tasks to be performed.

The collection module is also able to dynamically manage updates to the Type model while keeping the model live, when a type, schema link or other requirements module is updated it is published as a new Entity Type, for example Legal Entity Type Version 2, in parallel to the original version (Legal Entity Type Version 1). The collection module that issues any additional requirements to the user interface and the user interface allows the user to switch between both versions of the type model. The collection module then reports completeness against both the old and new type model. A type model change monitor module will in turn match onto the output ports of all collection modules affected by the change and monitor their completeness in total against the type model change, when all modules are complete the original Version 1 Entity type is withdrawn and the model automatically switched to the Version 2 Entity type. Any modules in the model no longer required are then withdrawn.

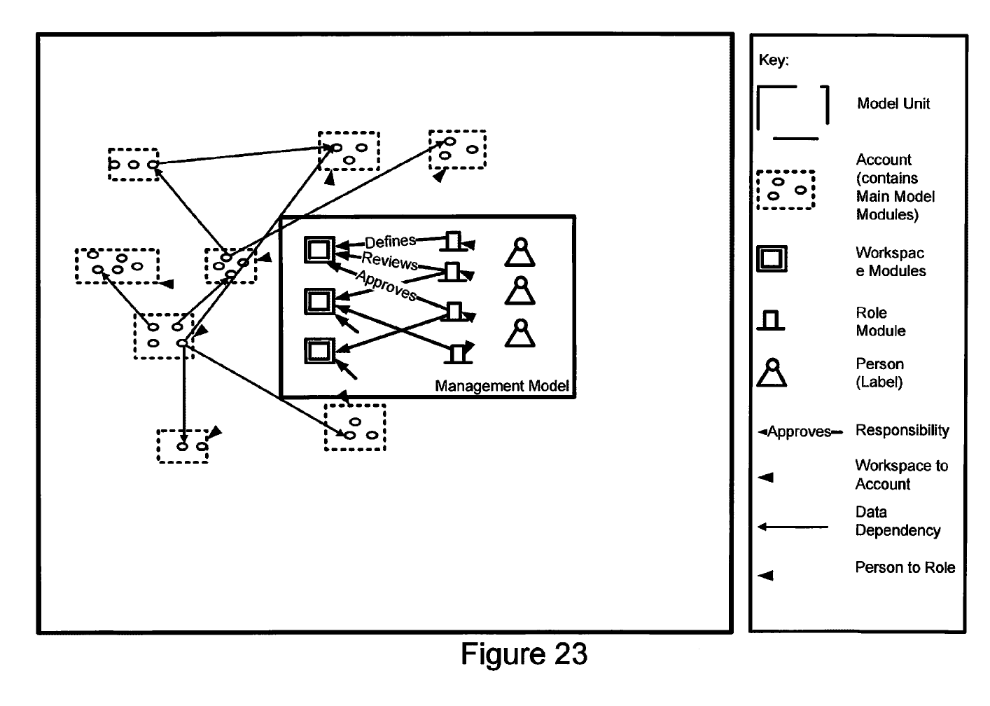

FIG. 23 is a diagram illustrating the relationship between model units and accounts together with the way users interact with them. Users fulfill roles in the system. The roles are defined as having responsibility types, such as Defines (to define parameters etc), Reviews (to review parameters etc), and Approves (to give approval of parameters to enable the parameters to be published to other users). The roles access workspace modules, which in turn access accounts in model units. Each model unit maintains a separate set of instantiations of business functions consistent with model wide definitions (collections, variable types, activity types and products types). The accounts can access shared data for the instantiation of the components of the model.

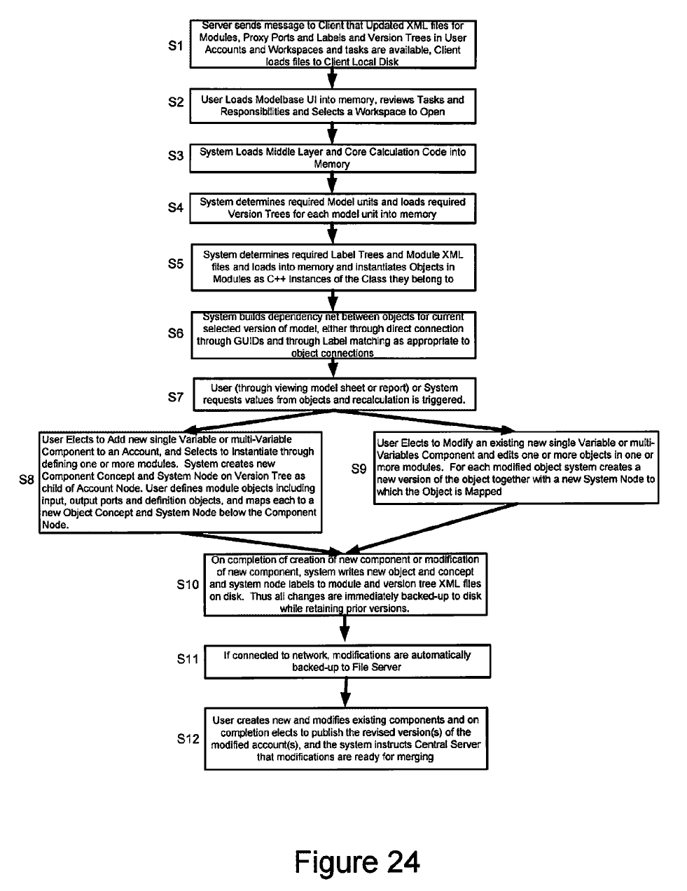

FIG. 24 is a flow diagram illustrating the process of creating or modifying components in the global model.

In step S1, the server sends a message to a Client that Updated XML files for Modules, Proxy Ports and Labels and Version Trees in User Accounts and Workspaces and tasks are available and the client loads the files to client local disk. In step S2, the user loads the model UI into memory, reviews tasks and responsibilities and selects a workspace to open. In step S3, the system loads middle layer and core calculation code into memory. In step S4, the system determines the required model units and loads required version trees for each model unit into memory. In step S5, the system determines required label trees and module XML files and loads them into memory and instantiates objects in modules as C++ instances of the class they belong to. In step S6, the system builds a dependency network between objects for the current selected version of model, through direct connection through IDs and through Label matching as appropriate to object connections. In step S7, the user (through viewing a model sheet or report) or the system requests values from objects and recalculation is triggered. In step S8, the user elects to add a new single variable or multi-variable component to an account, and selects to instantiate it by defining one or more modules. The system creates a new component concept and system node on the version tree as a child of the account node. The user defines module objects including input, output ports and definition objects, and maps each to a new object concept and system node below the a component node. In step S9, as an alternative to step S8, the user elects to modify an existing single variable or multi-variables component and edits one or more objects in one or more modules. For each modified object the system creates a new version of the object together with a new system node to which the object is mapped. In step S10, on completion of creation of a new component or modification of a new component, the system writes the new object and concept and system node labels to module and version tree XML files on disk. Thus all changes are immediately backed-up to disk while retaining prior versions. In step S11, if the client is connected to the network, the modifications are automatically backed-up to file server. In step S12, on completion of the creation of new components and the modification of existing components the user elects to publish the revised version(s) of the modified account(s), and the system instructs the central server that modifications are ready for merging.

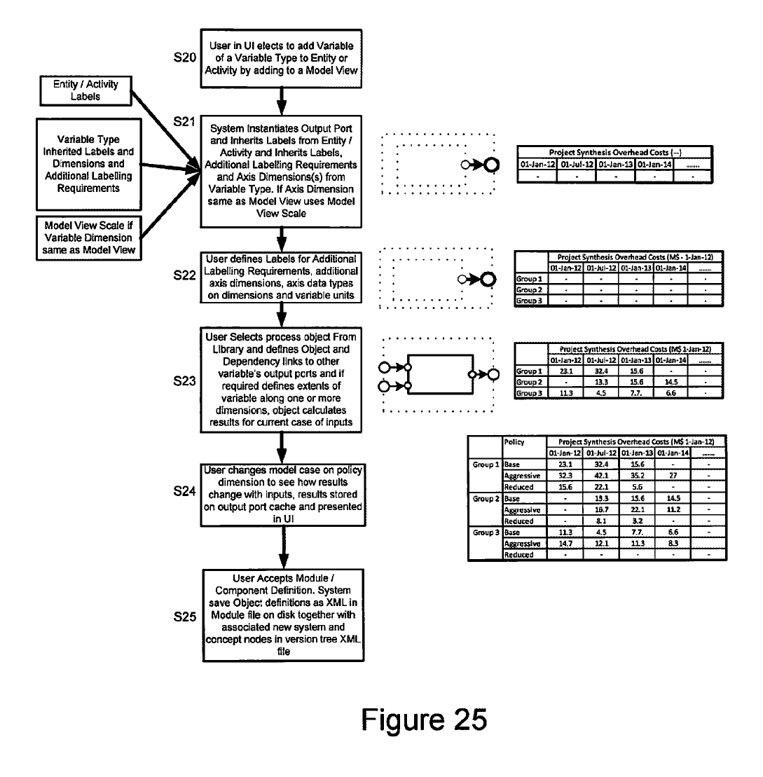

FIG. 25 illustrates the process for defining a single variable, single module component.

In step S20, a user uses the user interface on a client machine to add a variable of a variable type to an entity or activity by adding to a model view. In step S21, the system instantiates an output port object and inherits labels from the entity/activity and inherits labels, additional labelling requirements and axis dimensions(s) from variable type. If the axis dimension is the same as the model view the system uses the model view scale. In step S22, the user defines labels for additional labelling requirements, additional axis dimensions, axis data types on dimensions and variable units. In step S23, the user selects a process object from the library and defines object and dependency links to other variable's output ports and if required defines extents of variable along one or more dimensions. The object calculates the results for the current case of inputs. In step S24, the user changes the model case on the policy version dimension to see how results change with inputs. The results are stored on each output port object cache and presented in the user interface to the user. In step S25, the user accepts the module/component definition. The system saves the object definitions as XML in module file(s) on disk together with associated new system and concept nodes in a version tree XML file.

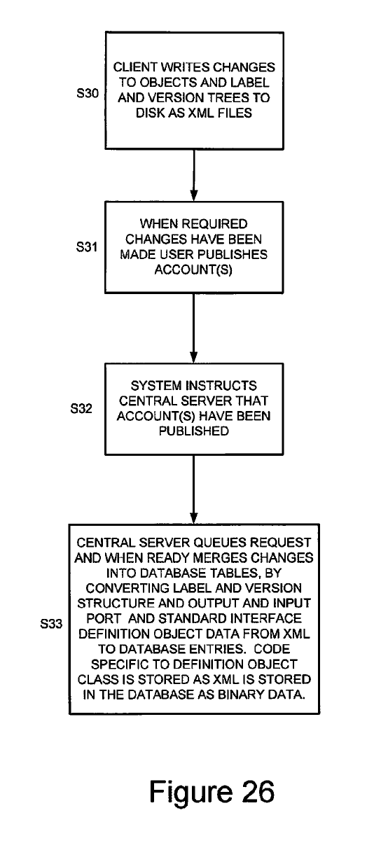

FIG. 26 illustrates the process for publishing the modification made by a user when the user is satisfied with them.

In step S30, the client writes the changes to objects and label and version trees to disk as XML files. In step S31, when required changes have been made, the user publishes the account(s). In step S32, the system instructs the central server that account(s) have been published. In step S33, the central server queues the request and when ready merges changes into the database tables by converting label and version structure and output and input port and standard interface process object data from XML to database entries. The code specific to the process object class stored as XML is stored in the database as binary data.

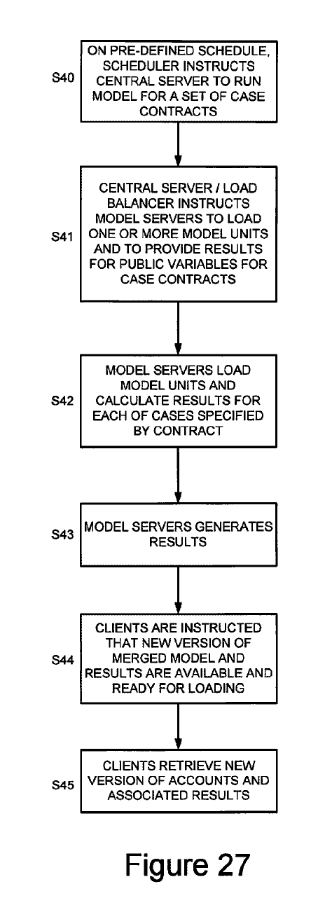

FIG. 27 illustrates the process for merging the data of the model.

In step S40, on a pre-defined schedule, a scheduler instructs the central server to run the model for a set of case contracts; case contracts define Cases of the model to be run and cached in terms of combinations of the Version Dimensions, these cases are defined in terms of the Model Synchronization table Version Dimension alternatives which maps these to the alternatives on the Version Dimensions of the Model Units. In step S41, the central server/load balancer instructs the model servers to load one or more model units and to provide results for public variables for case contracts. In step S42, the model servers load model units and calculate results for each of the cases specified by contract. In step S43, the model server generates the results. In step S44, clients are instructed that a new version of the merged model and results are available and ready for loading. In step S45, clients retrieve the new version of the accounts and associated results.

Templating enables parts of models that perform specific functions to be generalised and reused by others within the model. This greatly reduces the amount of work in the model and allows experts to create sophisticated components that are quality controlled for use by third parties.

Templating relies on the object and labelling system and operates through generalisation of labels. A user or a team of users of the system may create a model and elect to template a part of that model that performs a specific function. Typically a template describes a Variable, a Component, a Collection, an Account or a Model Unit.

A template is formed by selecting a set of objects to template and generalising labels of input and output ports.

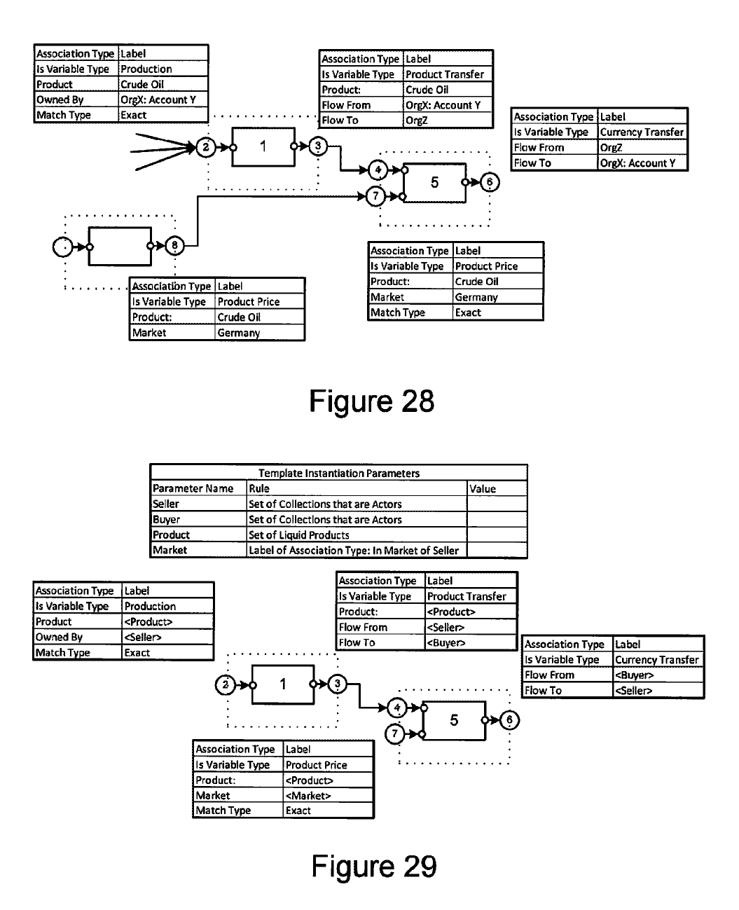

This is illustrated in FIG. 28. In this embodiment the Labels are applied as a pair or parameters, the Association Type and the Label concept, the Association Type combines the definition of the allowable set of Labels as compared with the three parameter Label arrangement described [0134] which has a separate Association Type and Label Type, this gives the opportunity to define sets defined by queries for the subjects and objects of associations and in turn gives additional flexibility for defining associations and creating a fluid data structure. FIG. 28 illustrates a calculation of a transaction for the sale of Crude Oil production from the account of one Organisation (OrgZ:AccountY) to another Organisation (OrgX). A Product Transfer Process Object (1) has a input port (2) that uses a label match to group Crude Oil Production from different sources belonging to OrgZ:AccountY, the Process Object consolidates these flows for Transfer to OrgX as designated by the Output Port (3). A Currency Transfer object (5) calculates the payment from OrgX to OrgZ:AccountY by connecting its input ports 4 and 7 to the output port of the Product Transfer (3) and the output port (8) in a market model that reports the Product Price for Crude Oil in the Market Germany.

It is desired to generalise the transaction objects as a template for reuse as illustrated in FIG. 29. The Product Transfer and Currency Transfer modules are selected to template, their internal connection Input port (4) to (5) is preserved, their Input and Output Ports are generalised by generalising their labels. To do this a number of template instantiation parameters are created together with Rules on where they can be drawn from, in this case the Parameters include the Seller, the Buyer both of which are drawn from the set of all Actors, the Product drawn from the set of all Actors, and the Market that is automatically determined from the Label of Association Type In Market of the Seller collection output port. The corresponding labels on the input and output ports are then generalised to the template instantiation parameters, OrgZ:AccountY becomes <Seller>, OrgX becomes <Buyer>, Crude Oil becomes <Product> and Germany becomes <Market>.

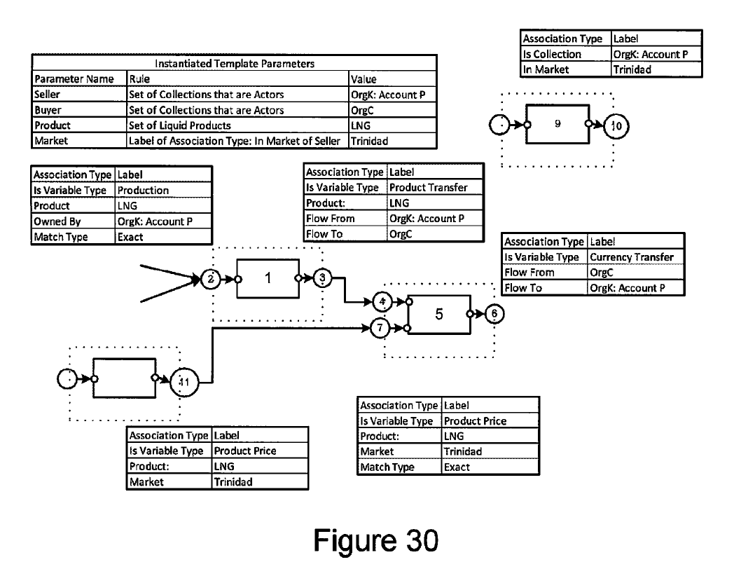

FIG. 30 illustrates the instantiation of the template. The person instantiating the template simply defines the Seller, the Buyer and Product in this example OrgK:AccountP, OrgC and NGL (natural gas liquids), the fourth parameter Market is automatically determined as Trinidad by referring to the Association Type, In Market, of Output Port (10) of the Collection Object (9) of the Seller, OrgK:AccountP. The generalised labels are now replaced with the specific labels and label matches made to NGL Production variables belonging to OrgK:AccountP on input Port (2) and to Market Norway NGL Price (10) on input Port (7). By making these connections the instantiated objects are able to calculate the Product and Currency Transfers between OrgK:AccountP and OrgC with no more input from the definer.

In the embodiments described above, the process objects primarily are described as performing processes or calculations. In alternative embodiments, the process objects can represent, be associated with or refer to digital content, such as text, image data, database data, spreadsheet cells etc. In such embodiments, the digital content can be processed by each process object dependent on prior objects in the dependency network. This provides for the management of digital content and for the shared processing of digital content by users, wherein digital content is broken down into parts each represented by a process object. Each version of a process object can refer to a respective version of a piece of digital content. The digital content can include dynamic components which are calculated as part of the instantiation of the process object or the process objects on which it depends. Hence, in embodiments, the model in the form of the dependency network can represent and manage versions of dynamic digital content by multiple users. In such embodiments, the business operation comprises the administrative operation of creating and managing digital content components to enable the construction of a complete version of a digital content item. The digital content can comprise text (documents), images, spreadsheet cells or database components or any combination thereof.

One embodiment provides a carrier medium such as a non-transient storage medium storing program code for controlling a processor of digital electronic device to carry out the method, or a transient medium carrying program code for controlling a processor of a digital electronic device to carry out the method. Embodiments can be implemented in programmable digital logic that implements computer code. The code can be supplied to the programmable logic, such as a processor or microprocessor, on a carrier medium. One such form of carrier medium is a transient medium i.e. a signal such as an electrical, electromagnetic, acoustic, magnetic, or optical signal. Another form of carrier medium is a non-transitory medium that carries or stores the code, such as a solid-state memory, magnetic media (hard disk drive), or optical media (Compact disc (CD) or digital versatile disc (DVD)).

Embodiments can be implemented on a number of computer servers in a system arranged to provide the functions described herein above.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method of modelling a business operation using a computer system, the method comprising:
receiving parameters for the instantiation of at least one process module from a user interface, each process module representing an element of the business operation and having at least one output port and at least one input port, each input port having at least one label, each label for an input port comprising at least one characteristic of a parameter required for input to the process module, each output port having at least one label, and each output port label comprising at least one characteristic of a parameter output by the process module, wherein the labels for the input and output ports are defined in structured data in sets;
storing in memory the parameters for the at least one process module; and
instantiating a plurality of process modules using at least one processor and the stored parameters to implement a model of the business operation by connecting inputs of modules to outputs of modules using the labels for the input and output ports to form a dependency network of process modules.

2. A method according to claim 1, wherein the labels for the inputs and output ports are defined as a hierarchy of labels.

3. A method according to claim 1, wherein connections between input ports and output ports of modules is determined by determining if the labels of the output ports match with the labels of the input ports, and making the connections where a match is determined.

4. A method according to claim 3, wherein the matching is based on matching rules defining matches for labels with identical labels and for labels for sets with labels for members of the respective sets.

5. A method according to claim 3, wherein each label stores association data identifying the relationship between the label and a label type in the structured data.

6. A method according to claim 1, wherein the structured data defining the labels comprises a data structure representation of an organization of resources associated with the business process.

7. A method according to claim 6, wherein the resources comprise entities involved in the business process, parameters involved in the business process, products involved in the business process, and activities between entities or on products

8. (canceled)

9. (canceled)

10. A method of modelling a business operation using a computer system, the method comprising:
receiving parameters for the instantiation of at least one process object and at least one translation object from a user interface, each process object comprising logic to perform a business function and having at least one input and at least one output, and each translation object comprising logic to convert the form of a parameter of a parameter type output from one process object into a required form for the parameter of the parameter type for input to another process object;
storing the parameters for the at least one process object and the at least one translation object in memory; and
instantiating a plurality of process objects and translation objects using a processor and the stored parameters to implement a model of the business operation by connecting inputs of process objects to outputs of process objects via translation objects to form a dependency network of objects.

11. A method according to claim 10, wherein each translation object is associated with an output of a respective process object to operate as an output port object operating as connection logic for connection to the input of a process object.

12. A method according to claim 11, wherein the received parameters are also for instantiation of an input port object for association with an input of each process object to provide connection logic, the parameters for the input port objects are stored, and the input port objects are instantiated using the processor in the implementation of the model by connecting inputs port objects of process objects to outputs port objects of process objects.

13. A method according to claim 12, wherein the input port logic defines required parameter types for the process object, and the instantiation by the processor comprises identifying output port objects with the required parameter types.

14. A method according to claim 13, wherein the parameter types comprise sets of parameter types and the identifying of output port objects comprises matching parameter type sets according to matching rules.

15. (canceled)

16. (canceled)

17. A method of modelling a business process using a computer system, the method comprising:
receiving parameters for the instantiation of at least one process object, at least one input connection object, and at least one output connection object from a user interface, each process object comprising logic representing a business function and requiring at least one input and at least one output, each input connection object comprising logic to input parameters to a process object, and each output connection object comprising logic to output parameters from a process object;
storing the parameters for the at least one process object, the at least one input connection object, and the at least one output connection object; and
instantiating a plurality of process objects and input and output connection objects using at least one processor and the stored parameters to implement a model of the business operation by connecting inputs of process objects to outputs of process objects via the connection objects to form a dependency network of objects.

18. (canceled)

19. (canceled)

20. A method of modelling a business process using a computer system, the method comprising:
receiving parameters to define a new version of at least one process module from a user interface when the parameters are different than for a previous version of the at least one process module, each process module comprising logic to represent a business function and having at least one input and at least one output, each version of a said process module being immutable and the output being dependent upon the input and the version of the process module;
storing the parameters for the at least one version of a said process module; and
instantiating a plurality of process modules using at least one processor and the stored parameters to implement a model of the business operation by connecting inputs of process modules to outputs of process modules to form a dependency network of process modules, process modules having associated versions being identified and connected to form the dependency network.

21. A method according to claim 20, wherein output data for each of a plurality of output cases of a process module is stored in a cache as case data for use when the version of the process module is instantiated, each output case being dependent upon and identified by different combinations of outputs of process modules on which the process module is directly or indirectly dependent and the versions of the process modules.

22. A method according to claim 20, wherein each output case of each version of a process module has a unique identifier and the unique identifier is stored in a data structure.

23. A method according to claim 22, wherein the data structure storing the unique identifier for the process modules is hierarchical and the process modules are grouped into a process component for performing a business function, wherein a version of a component is associated with a group of process modules having common parameters.

24. A method according to claim 20, wherein the new version of the process module is determined to be formed based on at least one of new user, time or a change in business assumptions, parameters, or decisions

25. (canceled)

26. (canceled)

27. A method of building a model of a business operation using a computer system, the method comprising:
receiving parameters for at least one at least one business factor from a user interface, the business factors representing an entity, an activity, or a product associated with the business operation;
storing the parameters for at least one at least one business factor;
instantiating business objects using at least one processor and the stored parameters to form a dependency network of business modules to determine conformance to requirements in a stored data structure;
receiving parameters for at least one process module from a user interface, each process module representing an element of the business process using or relying upon the business factors and having at least one output port and at least one input port;
storing the parameters for the at least one process module;
instantiating a plurality of process modules using at least one processor and the stored parameters to implement a model of the business operation by connecting inputs of modules to outputs of modules to form a dependency network of process modules.

28. (canceled)

29. (canceled)
